(19) United States
(12) Patent Application Publication
(10) Pub. No.: US 2025/0386332 A1
(43) Pub. Date: Dec. 18, 2025

(54) FREQUENCY RESOURCE CONFIGURATION FOR SYSTEM INFORMATION AND PAGING FOR ENHANCED REDUCED-CAPABILITY USER EQUIPMENTS

(71) Applicant: QUALCOMM Incorporated, San Diego, CA (US)

(72) Inventors: Hung Dinh LY, San Diego, CA (US); Yongjun KWAK, San Diego, CA (US); Kexin XIAO, Shanghai (CN)

(21) Appl. No.: 18/877,208

(22) PCT Filed: Aug. 9, 2022
(86) PCT No.: PCT/CN2022/111069

§ 371 Date: Dec. 19, 2024

(51) Int. Cl. H04W 72/0453; H04W 48/14; H04W 72/20; H04W 72/51

(52) U.S. Cl. CPC H04W 72/0453; H04W 48/14; H04W 72/20; H04W 72/51

(57) ABSTRACT

Methods, systems, and devices for wireless communications are described. A user equipment (UE) is configured to receive a first control message indicating a downlink bandwidth part (BWP) spanning a set of sub-bands in a frequency domain. The UE receives a system information block (SIB) within a first sub-band selected from the set of sub-bands based on a sub-band index associated with the first sub-band. The UE monitors, based on the SIB, a second sub-band for control signaling that schedules the UE to receive additional system information, and receives a second control message within the second sub-band based on monitoring the second sub-band, where the second control message schedules the UE to receive the additional system information.

### CROSS REFERENCE

The present application is a 371 national phase filing of International PCT Application No. PCT/CN2022/111069 by L Y et al., entitled “FREQUENCY RESOURCE CONFIGURATION FOR SYSTEM INFORMATION AND PAGING FOR ENHANCED REDUCED-CAPABILITY USER EQUIPMENTS,” filed Aug. 9, 2022, which is assigned to the assignee hereof, and which is expressly incorporated by reference in its entirety herein.

### FIELD OF TECHNOLOGY

The following relates to wireless communications, including frequency resource configuration for system information and paging for enhanced reduced-capability (eRedCap) user equipments (UEs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, wireless devices such as UEs may be configured to monitor control resource sets (CORESETs) to receive control information such as system information block (SIB) messages. An initial CORESET (e.g., CORESET0) may be configured for each UE via a master information block (MIB), where the size and location of the CORESET0 is used to determine the initial bandwidth part (BWP) that each UE is to monitor. However, some UEs may include reduced-capability (RedCap) UEs that are unable to monitor a frequency range spanned by the CORESET0.

### SUMMARY

The described techniques relate to improved methods, systems, devices, and apparatuses that support frequency resource configuration for system information and paging for enhanced reduced-capability (eRedCap) user equipments (UEs). Generally, aspects of the present disclosure are directed to rules and configurations for mapping sets of resources that are used to communicate system information blocks (SIBs), other system information (OSI), and paging messages for regular capacity UEs to sets of resources that are able to be monitored by RedCap UEs (e.g., eRedCap UEs). In particular, aspects of the present disclosure may enable eRedCap UEs to receive an indication of an initial bandwidth part (BWP), and determine a sub-band within the initial BWP that will be used for receiving a SIB, as well as additional sub-bands that will be used for receiving OSI and paging messages.

A method for wireless communication at a UE is described. The method may include receiving a first control message indicating a downlink BWP spanning a set of multiple sub-bands in a frequency domain, receiving a SIB within a first sub-band selected from the set of multiple sub-bands based on a sub-band index associated with the first sub-band, monitoring, based on the SIB, a second sub-band for control signaling that schedules the UE to receive additional system information, and receiving a second control message within the second sub-band based on monitoring the second sub-band, the second control message scheduling the UE to receive the additional system information.

An apparatus for wireless communication at a UE is described. The apparatus may include at least one processor, and memory coupled to the at least one processor, the memory storing instructions executable by the at least one processor to cause the UE to receive a first control message indicating a downlink BWP spanning a set of multiple sub-bands in a frequency domain, receive a SIB within a first sub-band selected from the set of multiple sub-bands based on a sub-band index associated with the first sub-band, monitor, based on the SIB, a second sub-band for control signaling that schedules the UE to receive additional system information, and receive a second control message within the second sub-band based on monitoring the second sub-band, the second control message scheduling the UE to receive the additional system information.

Another apparatus for wireless communication at a UE is described. The apparatus may include means for receiving a first control message indicating a downlink BWP spanning a set of multiple sub-bands in a frequency domain, means for receiving a SIB within a first sub-band selected from the set of multiple sub-bands based on a sub-band index associated with the first sub-band, means for monitoring, based on the SIB, a second sub-band for control signaling that schedules the UE to receive additional system information, and means for receiving a second control message within the second sub-band based on monitoring the second sub-band, the second control message scheduling the UE to receive the additional system information.

A non-transitory computer-readable medium storing code for wireless communication at a UE is described. The code may include instructions executable by at least one processor to receive a first control message indicating a downlink BWP spanning a set of multiple sub-bands in a frequency domain, receive a SIB within a first sub-band selected from the set of multiple sub-bands based on a sub-band index associated with the first sub-band, monitor, based on the SIB, a second sub-band for control signaling that schedules the UE to receive additional system information, and receive a second control message within the second sub-band based on monitoring the second sub-band, the second control message scheduling the UE to receive the additional system information.

Some examples of the method, apparatuses, and non-transitory computer-readable medium described herein may further include operations, features, means, or instructions for receiving, via the SIB, an indication of the second sub-band, where receiving the second control message may be based on receiving the indication of the second sub-band and receiving the additional system information via the second sub-band based on receiving the indication of the second sub-band.

Some examples of the method, apparatuses, and non-transitory computer-readable medium described herein may further include operations, features, means, or instructions for receiving, via the SIB, an indication of the second sub-band and an indication of a third sub-band, where receiving the second control message may be based on receiving the indication of the second sub-band and receiving the additional system information via the third sub-band based on receiving the indication of the third sub-band.

Some examples of the method, apparatuses, and non-transitory computer-readable medium described herein may further include operations, features, means, or instructions for selecting the first sub-band as the second sub-band based on an absence of an indication of an additional sub-band within the SIB, where the second control message may be received within the first sub-band based on the selecting.

Some examples of the method, apparatuses, and non-transitory computer-readable medium described herein may further include operations, features, means, or instructions for receiving the additional system information via the first sub-band based on selecting the first sub-band as the second sub-band, based on receiving the second control message via the first sub-band, or both.

Some examples of the method, apparatuses, and non-transitory computer-readable medium described herein may further include operations, features, means, or instructions for receiving a third control message that schedules the SIB within the first sub-band of the set of multiple sub-bands and monitoring the first sub-band for the SIB based on receiving the third control message via the first sub-band, where receiving the SIB may be based on the monitoring.

Some examples of the method, apparatuses, and non-transitory computer-readable medium described herein may further include operations, features, means, or instructions for receiving a third control message that schedules the SIB, the third control message including an indication of the first sub-band and monitoring the first sub-band for the SIB based on receiving the indication of the first sub-band, where receiving the SIB may be based on the monitoring.

In some examples of the method, apparatuses, and non-transitory computer-readable medium described herein, the indication of the first sub-band includes a cyclic redundancy check (CRC) portion of the third control message that may be scrambled based on a system information radio network temporary identifier (SI-RNTI).

In some examples of the method, apparatuses, and non-transitory computer-readable medium described herein, the information radio network temporary identifier may be associated with eRedCap UEs and the UE includes an eRedCap UE.

Some examples of the method, apparatuses, and non-transitory computer-readable medium described herein may further include operations, features, means, or instructions for receiving, via the second control message, an indication of a third sub-band for receiving the additional system information, where the third sub-band may be the same or different as the first sub-band, the second sub-band, or both and receiving the additional system information within the third sub-band based on receiving the indication of the third sub-band.

Some examples of the method, apparatuses, and non-transitory computer-readable medium described herein may further include operations, features, means, or instructions for receiving, via the second control message, an indication of a first subset of sub-bands associated with broadcast system information, and an indication of a second subset of sub-bands associated with on-demand system information, the second subset of sub-bands different from the first subset of sub-bands, where the second sub-band may be included within the first subset of sub-bands if the additional system information includes broadcast system information, or where the second sub-band may be included within the second subset of sub-bands if the additional system information includes on-demand system information.

Some examples of the method, apparatuses, and non-transitory computer-readable medium described herein may further include operations, features, means, or instructions for transmitting, based on the second control message, a request for the additional system information based on the additional system information including on-demand system information and receiving the additional system information within the second sub-band based on the request.

Some examples of the method, apparatuses, and non-transitory computer-readable medium described herein may further include operations, features, means, or instructions for receiving, via the second control message, an indication of a first subset of sub-bands associated with a first type of additional system information, and an indication of a second subset of sub-bands associated with a second type of additional system information, the second subset of sub-bands different from the first subset of sub-bands, where the second sub-band may be included within the first subset of sub-bands if the additional system information may be of the first type, or where the second sub-band may be included within the second subset of sub-bands if the additional system information may be of the second type.

Some examples of the method, apparatuses, and non-transitory computer-readable medium described herein may further include operations, features, means, or instructions for receiving an indication of a common set of sub-bands associated with broadcast system information, on-demand system information, a first type of additional system information, a second type of additional system information, or any combination thereof.

Some examples of the method, apparatuses, and non-transitory computer-readable medium described herein may further include operations, features, means, or instructions for selecting a third sub-band of the set of multiple sub-bands based on an additional sub-band index associated with the third sub-band, where the third sub-band may be the same or different as the first sub-band, the second sub-band, or both and receiving a third control message within the third sub-band, where the third control message schedules the UE to receive the SIB.

In some examples of the method, apparatuses, and non-transitory computer-readable medium described herein, each sub-band of the set of multiple sub-bands may be associated with a respective sub-band index and the method, apparatuses, and non-transitory computer-readable medium may include further operations, features, means, or instructions for selecting the third sub-band based on the additional sub-band index associated with the third sub-band including a highest sub-band index of the set of multiple sub-band indices, or based on the additional sub-band index including a lowest sub-band index of the set of multiple sub-band indices.

Some examples of the method, apparatuses, and non-transitory computer-readable medium described herein may further include operations, features, means, or instructions for determining the additional sub-band index associated with the third sub-band based on a system frame number (SFN), a slot index, or both, where the SFN, the slot index, or both, may be indicated via the first control message, determined based on a timing of the first control message, or both.

Some examples of the method, apparatuses, and non-transitory computer-readable medium described herein may further include operations, features, means, or instructions for selecting the sub-band of the set of multiple sub-bands may be based on the UE including an eRedCap UE.

Some examples of the method, apparatuses, and non-transitory computer-readable medium described herein may further include operations, features, means, or instructions for receiving, via the first control message, the second control message, a paging tracking reference signal (TRS), paging permanent equipment identifier (PEI) message, or any combination thereof, an indication of a third sub-band associated with paging resources for the UE, where the third sub-band may be the same or different as the first sub-band, the second sub-band, or both and monitoring the third sub-band for a paging message based on receiving the indication of the third sub-band.

Some examples of the method, apparatuses, and non-transitory computer-readable medium described herein may further include operations, features, means, or instructions for receiving the paging message based on monitoring the third sub-band, where the paging message schedules the UE to receive a downlink message within a fourth sub-band, where the fourth sub-band may be the same or different as the first sub-band, the second sub-band, the third sub-band, or any combination thereof and receiving the downlink message within the fourth sub-band based on the paging message.

In some examples of the method, apparatuses, and non-transitory computer-readable medium described herein, the second sub-band used to receive the second control message that schedules the additional system information may be included within a first subset of the set of multiple sub-bands and the third sub-band used to receive the paging message may be included within a second subset of the set of multiple sub-bands that may be different from the first subset.

In some examples of the method, apparatuses, and non-transitory computer-readable medium described herein, the first control message includes a master information block (MIB).

In some examples of the method, apparatuses, and non-transitory computer-readable medium described herein, the second sub-band may be included within the set of multiple sub-bands spanned by the downlink BWP.

A method for wireless communication at a network entity is described. The method may include transmitting, to a UE, a first control message indicating a downlink BWP spanning a set of multiple sub-bands in a frequency domain, transmitting a SIB to the UE within a first sub-band selected from the set of multiple sub-bands based on a sub-band index associated with the first sub-band, and transmitting a second control message to the UE within the second sub-band, where the second sub-band is based on the SIB, and where the second control message schedules the UE to receive additional system information.

An apparatus for wireless communication at a network entity is described. The apparatus may include at least one processor, and memory coupled to the at least one processor, the memory storing instructions executable by the at least one processor to cause the network entity to transmit, to a UE, a first control message indicating a downlink BWP spanning a set of multiple sub-bands in a frequency domain, transmit a SIB to the UE within a first sub-band selected from the set of multiple sub-bands based on a sub-band index associated with the first sub-band, and transmit a second control message to the UE within the second sub-band, where the second sub-band is based on the SIB, and where the second control message schedules the UE to receive additional system information.

Another apparatus for wireless communication at a network entity is described. The apparatus may include means for transmitting, to a UE, a first control message indicating a downlink BWP spanning a set of multiple sub-bands in a frequency domain, means for transmitting a SIB to the UE within a first sub-band selected from the set of multiple sub-bands based on a sub-band index associated with the first sub-band, and means for transmitting a second control message to the UE within the second sub-band, where the second sub-band is based on the SIB, and where the second control message schedules the UE to receive additional system information.

A non-transitory computer-readable medium storing code for wireless communication at a network entity is described. The code may include instructions executable by at least one processor to transmit, to a UE, a first control message indicating a downlink BWP spanning a set of multiple sub-bands in a frequency domain, transmit a SIB to the UE within a first sub-band selected from the set of multiple sub-bands based on a sub-band index associated with the first sub-band, and transmit a second control message to the UE within the second sub-band, where the second sub-band is based on the SIB, and where the second control message schedules the UE to receive additional system information.

Some examples of the method, apparatuses, and non-transitory computer-readable medium described herein may further include operations, features, means, or instructions for transmitting, via the SIB, an indication of the second sub-band, where transmitting the second control message may be based on transmitting the indication of the second sub-band and transmitting the additional system information via the second sub-band based on transmitting the indication of the second sub-band.

Some examples of the method, apparatuses, and non-transitory computer-readable medium described herein may further include operations, features, means, or instructions for transmitting, via the SIB, an indication of the second sub-band and an indication of a third sub-band, where transmitting the second control message may be based on transmitting the indication of the second sub-band and transmitting the additional system information via the third sub-band based on transmitting the indication of the third sub-band.

Some examples of the method, apparatuses, and non-transitory computer-readable medium described herein may further include operations, features, means, or instructions for selecting the first sub-band as the second sub-band based on an absence of an indication of an additional sub-band within the SIB, where the second control message may be transmitted within the first sub-band based on the selecting.

Some examples of the method, apparatuses, and non-transitory computer-readable medium described herein may further include operations, features, means, or instructions for transmitting the additional system information via the first sub-band based on selecting the first sub-band as the second sub-band, based on transmitting the second control message via the first sub-band, or both.

Some examples of the method, apparatuses, and non-transitory computer-readable medium described herein may further include operations, features, means, or instructions for transmitting a third control message that schedules the SIB within the first sub-band of the set of multiple sub-bands, where transmitting the SIB may be based on the third control message.

Some examples of the method, apparatuses, and non-transitory computer-readable medium described herein may further include operations, features, means, or instructions for transmitting a third control message that schedules the SIB, the third control message including an indication of the first sub-band, where transmitting the SIB may be based on the third control message.

In some examples of the method, apparatuses, and non-transitory computer-readable medium described herein, the indication of the first sub-band includes a CRC portion of the third control message that may be scrambled based on a system information radio network temporary identifier.

In some examples of the method, apparatuses, and non-transitory computer-readable medium described herein, the information radio network temporary identifier may be associated with eRedCap UEs and the UE includes an eRedCap UE.

Some examples of the method, apparatuses, and non-transitory computer-readable medium described herein may further include operations, features, means, or instructions for transmitting, via the second control message, an indication of a third sub-band for transmitting the additional system information, where the third sub-band may be the same or different as the first sub-band, the second sub-band, or both and transmitting the additional system information to the UE within the third sub-band based on transmitting the indication of the third sub-band.

Some examples of the method, apparatuses, and non-transitory computer-readable medium described herein may further include operations, features, means, or instructions for transmitting, via the second control message, an indication of a first subset of sub-bands associated with broadcast system information, and an indication of a second subset of sub-bands associated with on-demand system information, the second subset of sub-bands different from the first subset of sub-bands, where the second sub-band may be included within the first subset of sub-bands if the additional system information includes broadcast system information, or where the second sub-band may be included within the second subset of sub-bands if the additional system information includes on-demand system information.

Some examples of the method, apparatuses, and non-transitory computer-readable medium described herein may further include operations, features, means, or instructions for receiving, from the UE based on the second control message, a request for the additional system information based on the additional system information including on-demand system information and transmitting the additional system information within the second sub-band based on the request.

Some examples of the method, apparatuses, and non-transitory computer-readable medium described herein may further include operations, features, means, or instructions for transmitting, via the second control message, an indication of a first subset of sub-bands associated with a first type of additional system information, and an indication of a second subset of sub-bands associated with a second type of additional system information, the second subset of sub-bands different from the first subset of sub-bands, where the second sub-band may be included within the first subset of sub-bands if the additional system information includes the first type, or where the second sub-band may be included within the second subset of sub-bands if the additional system information includes the second type.

Some examples of the method, apparatuses, and non-transitory computer-readable medium described herein may further include operations, features, means, or instructions for selecting a third sub-band of the set of multiple sub-bands based on an additional sub-band index associated with the third sub-band, where the third sub-band may be the same or different as the first sub-band, the third sub-band, or both and transmitting a third control message from the network entity within the third sub-band, where the third control message schedules the UE to receive the SIB.

In some examples of the method, apparatuses, and non-transitory computer-readable medium described herein, each sub-band of the set of multiple sub-bands may be associated with a respective sub-band index and the method, apparatuses, and non-transitory computer-readable medium may include further operations, features, means, or instructions for selecting the third sub-band based on the additional sub-band index associated with the third sub-band including a highest sub-band index of the set of multiple sub-band indices, or based on the additional sub-band index including a lowest sub-band index of the set of multiple sub-band indices.

Some examples of the method, apparatuses, and non-transitory computer-readable medium described herein may further include operations, features, means, or instructions for determining the additional sub-band index associated with the third sub-band based on an SFN, a slot index, or both, where the SFN, the slot index, or both, may be indicated via the first control message, determined based on a timing of the first control message, or both.

Some examples of the method, apparatuses, and non-transitory computer-readable medium described herein may further include operations, features, means, or instructions for selecting the sub-band of the set of multiple sub-bands may be based on the UE including an eRedCap UE.

Some examples of the method, apparatuses, and non-transitory computer-readable medium described herein may further include operations, features, means, or instructions for transmitting, via the first control message, the second control message, a paging TRS, paging PEI message, or any combination thereof, an indication of a third sub-band associated with paging resources for the UE, where the third sub-band may be the same or different as the first sub-band, the second sub-band, or both.

Some examples of the method, apparatuses, and non-transitory computer-readable medium described herein may further include operations, features, means, or instructions for transmitting the paging message based within the third sub-band based on the indication of the third sub-band, where the paging message schedules the UE to receive a downlink message within a fourth sub-band, where the fourth sub-band may be the same or different as the first sub-band, the second sub-band, the third sub-band, or any combination thereof and transmitting the downlink message to the UE within the fourth sub-band based on the paging message.

In some examples of the method, apparatuses, and non-transitory computer-readable medium described herein, the second sub-band used to transmit the second control message that schedules the additional system information may be included within a first subset of the set of multiple sub-bands and the third sub-band used to transmit the paging message may be included within a second subset of the set of multiple sub-bands that may be different from the first subset.

In some examples of the method, apparatuses, and non-transitory computer-readable medium described herein, the first control message includes a MIB.

In some examples of the method, apparatuses, and non-transitory computer-readable medium described herein, the second sub-band may be included within the set of multiple sub-bands spanned by the downlink BWP.

### BRIEF DESCRIPTION OF THE DRAWINGS

FIG. 1 illustrates an example of a wireless communications system that supports frequency resource configuration for system information and paging for enhanced reduced-capability (eRedCap) user equipments (UEs) in accordance with one or more aspects of the present disclosure.

FIG. 2 illustrates an example of a wireless communications system that supports frequency resource configuration for system information and paging for eRedCap UEs in accordance with one or more aspects of the present disclosure.

FIG. 3 illustrates an example of a resource configuration that supports frequency resource configuration for system information and paging for eRedCap UEs in accordance with one or more aspects of the present disclosure.

FIG. 4 illustrates an example of a resource configuration that supports frequency resource configuration for system information and paging for eRedCap UEs in accordance with one or more aspects of the present disclosure.

FIG. 5 illustrates an example of a process flow that supports frequency resource configuration for system information and paging for eRedCap UEs in accordance with one or more aspects of the present disclosure.

FIGS. 6 and 7 show block diagrams of devices that support frequency resource configuration for system information and paging for eRedCap UEs in accordance with one or more aspects of the present disclosure.

FIG. 8 shows a block diagram of a communications manager that supports frequency resource configuration for system information and paging for eRedCap UEs in accordance with one or more aspects of the present disclosure.

FIG. 9 shows a diagram of a system including a device that supports frequency resource configuration for system information and paging for eRedCap UEs in accordance with one or more aspects of the present disclosure.

FIGS. 10 and 11 show block diagrams of devices that support frequency resource configuration for system information and paging for eRedCap UEs in accordance with one or more aspects of the present disclosure.

FIG. 12 shows a block diagram of a communications manager that supports frequency resource configuration for system information and paging for eRedCap UEs in accordance with one or more aspects of the present disclosure.

FIG. 13 shows a diagram of a system including a device that supports frequency resource configuration for system information and paging for eRedCap UEs in accordance with one or more aspects of the present disclosure.

FIGS. 14 through 16 show flowcharts illustrating methods that support frequency resource configuration for system information and paging for eRedCap UEs in accordance with one or more aspects of the present disclosure.

### DETAILED DESCRIPTION

In some wireless communications systems, wireless devices (e.g., user equipments (UEs)) are configured to monitor control resource sets (CORESETs) to receive control information such as system information blocks (SIBs) and other system information (OSI). An initial CORESET0 is configured for each UE via a master information block (MIB), where the size and location of the CORESET0 is used to determine the initial bandwidth part (BWP) that each UE is to monitor.

However, conventional CORESETs and BWPs generally span frequency ranges that are larger than those for which a reduced capability (RedCap) UE is able to monitor. For example, some RedCap UEs exhibit limited processing capabilities and are only able to monitor a maximum of 5 MHz, where an initial CORESET0 may exhibit a frequency range of 20 MHz or greater. As such, RedCap UEs may not be able to monitor traditional CORESETs or BWPs.

Accordingly, aspects of the present disclosure are directed to rules and configurations for mapping sets of resources that are used to communicate SIBs, OSI, and paging messages for regular capacity UEs to sets of resources that are able to be monitored by RedCap UEs. In particular, techniques described herein enable eRedCap UEs to receive an indication of an initial BWP, and determine a sub-band within the initial BWP that will be used for receiving a SIB, as well as additional sub-bands that will be used for receiving OSI and paging messages.

For example, the RedCap UE is configured with an initial BWP and selects a sub-band for receiving a SIB based on a sub-band index (e.g., highest or lowest sub-band index). Subsequently, the UE will determine an additional sub-band for monitoring and/or receiving OSI based on the SIB. For instance, the SIB may explicitly indicate the sub-bands for physical downlink control channel (PDCCH) and/or physical downlink shared channel (PDSCH) OSI. Additionally, or alternatively, if the SIB does not indicate a new sub-band for OSI, the sub-band(s) for OSI reception may be the same as the sub-band used to receive the SIB. Moreover, different subsets of sub-bands may be configured for OSI and paging messages.

Aspects of the disclosure are initially described in the context of wireless communications systems. Additional aspects of the disclosure are described in the context of example resource configurations and an example process flow. Aspects of the disclosure are further illustrated by and described with reference to apparatus diagrams, system diagrams, and flowcharts that relate to frequency resource configuration for system information and paging for eRedCap UEs.

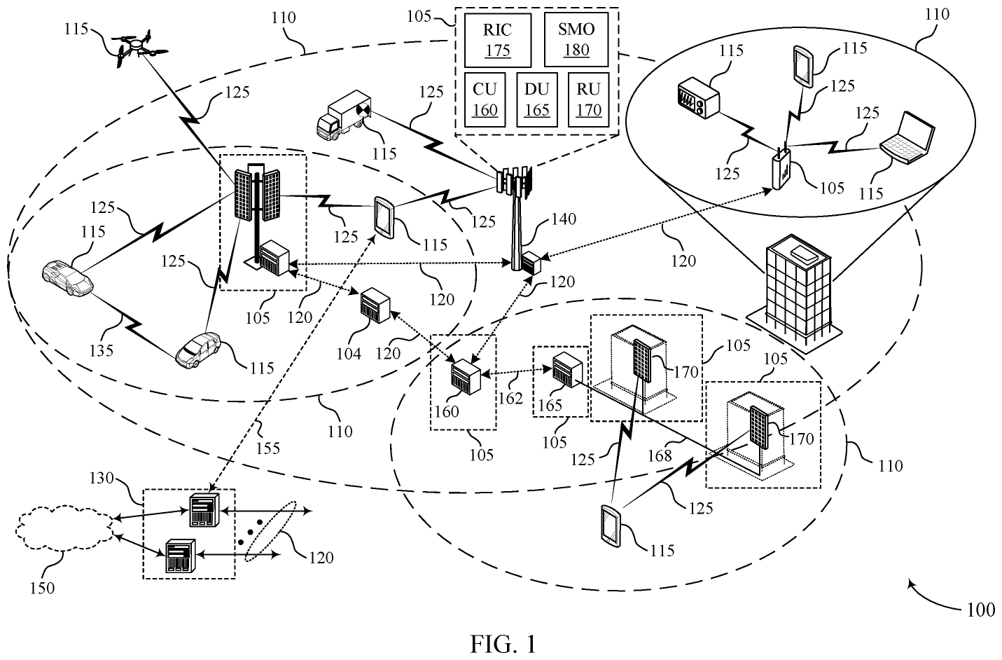

FIG. 1 illustrates an example of a wireless communications system 100 that supports frequency resource configuration for system information and paging for eRedCap UEs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support frequency resource configuration for system information and paging for eRedCap UEs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, the wireless communications system 100 may support rules and configurations for mapping sets of resources that are used to communicate SIBs, OSI, and paging messages for regular capacity UEs 115 to sets of resources that are able to be monitored by RedCap UEs 115, including eRedCap UEs 115. In particular, the wireless communications system 100 may enable eRedCap UEs 115 to receive an indication of an initial BWP, and determine a sub-band within the initial BWP that will be used for receiving a SIB, as well as additional sub-bands that will be used for receiving OSI and paging messages.

For example, according to some aspects of the present disclosure, a RedCap UE 115 may be configured with an initial BWP, and may select a sub-band for receiving a SIB based on a sub-band index (e.g., highest or lowest sub-band index). Subsequently, the UE 115 may determine an additional sub-band for monitoring and/or receiving OSI based on the SIB. For instance, the SIB may explicitly indicate the sub-bands for PDCCH and/or PDSCH OSI. Additionally, or alternatively, if the SIB does not indicate a new sub-band for OSI, the sub-band(s) for OSI reception may be the same as the sub-band used to receive the SIB. Moreover, different subsets of sub-bands may be configured for OSI and paging messages.

Techniques described herein may enable eRedCap UEs 115 to be configured with CORESETs and/or BWPs capable of being monitored by regular, full-capability UEs 115 and identify CORESETs/BWPs that are capable of being monitored by eRedCap UEs 115 for receiving SIBs, OSI, paging messages, or any combination thereof. As such, aspects of the present disclosure may enable traditional control signaling used to configure CORESETs/BWPs for regular-capacity UEs 115 to be used to configure CORESETs/BWPs for eRedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 for receiving OSI and paging messages so that the RedCap UEs 115 and the network can be in sync with one another with respect to which resources will be used to communicate such messages. As such, techniques described herein may improve an efficiency and reliability of wireless communications between RedCap UEs 115 and the network.

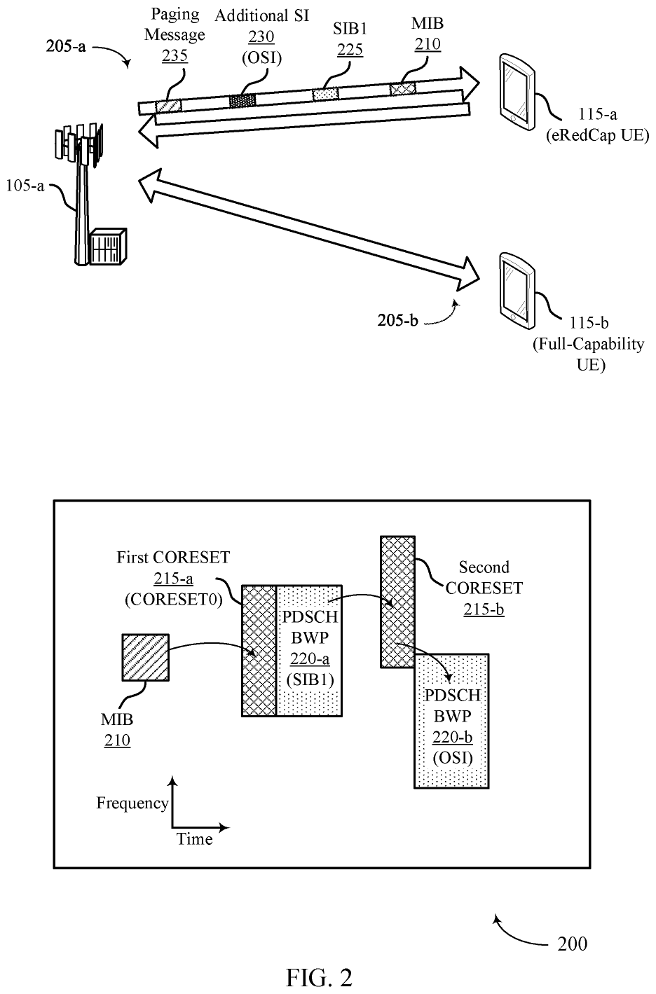

FIG. 2 illustrates an example of a wireless communications system 200 that supports frequency resource configuration for system information and paging for eRedCap UEs in accordance with one or more aspects of the present disclosure. In some examples, aspects of the wireless communications system 200 may implement, or be implemented by, aspects of the wireless communications system 100. In particular, the wireless communications system 200 may support rules or configurations for mapping sets of resources that are expected to be monitored by normal, regular-capability UEs 115 to sets of resources that are able to be monitored by RedCap UEs 115, including eRedCap UEs 115.

The wireless communications system 200 may include a network entity 105-a, a first UE 115-a (e.g., RedCap UE 115, or eRedCap UE 115), and a second UE 115-b (e.g., full-capability UE 115). The first UE 115-a and the second UE 115-b may communicate with the network entity 105-a using communication links 205-a and 205-b, respectively, which may be examples of NR or LTE links between the respective UEs 115 and the network entity 105-a. In some cases, the communication links 205 may include examples of access links (e.g., Uu links) which may include a bi-directional link that enables both uplink and downlink communication. For example, the first UE 115-a may transmit uplink signals, such as uplink control signals or uplink data signals, to one or more components of the network entity 105-a using the communication link 205-a, and one or more components of the network entity 105-a may transmit downlink signals, such as downlink control signals or downlink data signals, to the UE 115-a using the communication link 205-a.

As shown in FIG. 2, the network entity 105-a of the wireless communications system 200 may be configured to support both regular, full-capability user equipments UEs 115 as well as RedCap UEs 115. For example, the second UE 115-b may include an example of a full-capability (e.g., full-bandwidth) UE 115-b, whereas the first UE 115-a may include an example of a RedCap UE 115 (e.g., reduced-bandwidth UE 115-a), such as an eRedCap UE 115. The eRedCap UE 115-a may exhibit a reduced capability as compared to the full-capability UE 115-b with respect to one or more parameters, including a bandwidth over which it may communicate, processing capabilities, peak data rates, quantities of antennas, or any combination thereof. For instance, in some cases, the first UE 115-a may include a bandwidth capability below a given threshold, and may communicate with the network entity 105-a over a reduced bandwidth as compared to full-capability UE 115-b.

In some cases, the wireless communications system 200 may be configured to support wireless communications with wireless devices (e.g., UEs 115) that exhibit varying processing capabilities. Wireless devices may be categorized into different classes or categories of wireless devices. Classes or categories of wireless devices may include: (1) an enhanced mobile broadband (eMBB) category, (2) a RedCap category (e.g., NR-light), and (3) an eRedCap category (e.g., NR-superlight).

The eMBB category may include wireless devices that exhibit the highest complexity or performance, and may therefore include wireless devices that are able to support URLLC communications, such as high-end smartphones and high-performance sensors. Comparatively, the RedCap category may include wireless devices that exhibit lower performance/capability as compared to the eMBB category. For example, the RedCap category may include industrial wireless sensors, low-end smartphones, health monitors, video surveillance devices, high-end wearables, and high-end logistic trackers. Lastly, the eRedCap category may include wireless devices that exhibit the lowest complexity or performance, such as NB-IoT devices (e.g., massive IoT devices) and low-power wide-area (LPWA) wireless devices. For example, the eRedCap category may include low-end industrial wireless sensors, parking sensors, agricultural sensors, utility meters, low-end wearables, and low-end asset trackers.

In this regard, wireless devices categorized into the respective categories may exhibit varying complexities, processing powers, and capabilities. For example, eMBB and/or RedCap devices may be able to monitor larger spans of resources in the frequency domain as compared to eRedCap devices. For instance, eMBB devices and RedCap devices may be able to monitor a set of resources spanning up to 20 MHz in the frequency domain, whereas eRedCap devices may be able to monitor a set of resources spanning only up to 5 MHz (e.g., 24 PRB with 15 kHz SCS) in the frequency domain.

In some aspects, the network entity 105-a may transmit system information to the UEs 115, where the system information includes various information that enable the UEs 115 to communicate with the network within the wireless communications system 100. In some cases, system information within the wireless communications system 100 may be divided up into different categories, including “minimum system information,” which may include a MIB 210 and a SIB1, and “additional system information” or “OSI,” which may include SIB2, SIB3, SIB4, etc.

For example, as shown in FIG. 2, in some implementations, the network entity 105-a may transmit a MIB 210 (and/or SSB), where the MIB 210 (or SSB) indicates a first CORESET 215-a (e.g., CORESET0) and/or a first BWP 220-a (e.g., initial BWP 220-a). In some aspects, the MIB 210 be periodically broadcast on a broadcast channel (BCH). In some cases, the resources used to transmit the MIB 210 and/or SSB may be included within the initial BWP 220-a in the frequency domain. The bandwidth of the first CORESET 215-a may be no larger than the bandwidth of the initial BWP 220-a. In some aspects, PDSCH carrying a SIB 225 (e.g., SIB1) may be scheduled within the initial BWP 220-a. Moreover, the PDSCH may be quasi co-located (QCLed) with an SSB.

In some aspects, the SIB1 may be periodically broadcast via a downlink shared channel (DL-SCH), or unicast via the DL-SCH. In some aspects, a SIB 225 (e.g., SIB1) received within the initial BWP 220-a may indicate broadcast or non-broadcast OSI 230. In other words, the SIB1 received within the initial BWP 220-a may indicate or configure a second CORESET 215-b, where the first UE 115-a is configured to monitor the second CORESET 215-b for additional system information (e.g., OSI 230). As such, control messages received within the second CORESET 220-b may schedule PDSCH messages carrying OSI 230 within a second BWP 220-b. In some aspects, PDSCH messages carrying OSI 230 may be associated with (e.g., configured by) a TCI state which is different from the SSB that indicates the first CORESET 215-a.

The OSI 230 (e.g., SIB2, SIB3, etc.) may be periodically broadcast via the DL-SCH, broadcast on-demand via the DL-SCH, unicast on the DL-SCH, or any combination thereof. In this regard, OSI 230 may be divided up into two different categories, including broadcast system information and on-demand system information. The UEs 115 may receive broadcast system information without transmitting a request. Comparatively, on-demand system information may be broadcast via the DL-SCH in response to requests from respective UEs 115 (e.g., upon request from UEs 115 in RRC_IDLE or RRC_INACTIVE). Additionally, or alternatively, on-demand OSI 230 may be transmitted in a dedicated manner on DL-SCH to UEs 115 in RRC_CONNECTED. For UEs 115 in RRC_IDLE and RRC_INACTIVE, a request for OSI 230 may trigger a random access procedure at the respective UE 115.

In some cases, the SIB 225 (e.g., SIB1) may indicate the type of OSI 230 messages that are available to the UEs 115 (e.g., indicate whether OSIs 230 are broadcast system information, or on-demand system information). In this regard, after reading scheduling information for OSI 230 indicated via the SIB1, the UEs 115 may be configured to determine broadcast statuses (e.g., via a si-BroadcastStatus field) for OSI 230 messages, where the broadcast status field indicates if one or several SIBs within the system information message are being broadcasted or not. If the broadcast status field (e.g., si-BroadcastStatus) for a SIB 225 or OSI 230 is set to “broadcasting,” the UEs 115 may acquire the respective SIB 225/OSI 230 normally (e.g., by monitoring resources, and without transmitting a request). Comparatively, if the broadcast status field for a SIB 225 or OSI 230 is set to “notbroadcasting” or “on-demand,” the UEs 115 may proceed with a random access procedure to acquire the respective SIB 225/OSI 230 (e.g., by transmitting a request for the on-demand system information). In cases where the network configures the UEs 115 with physical random access channel (PRACH) resources for transmitting system information requests, a contention-free random access procedure (CFRA) may be used. Otherwise, a contention-based random access (CBRA) procedure may be used.

In additional or alternative implementations, the second CORESET 215-b and/or the second BWP 220-b may be used to deliver paging messages to the UEs 115. In this regard, the first UE 115-a may be configured to monitor paging resources (e.g., PDCCH) and receive scheduled paging PDSCH messages within the initial BWP 220-a and/or the second BWP 220-b, if configured. In the context of UE paging, paging messages may be transmitted to UEs 115 to indicate when message traffic is waiting to be delivered to the UEs 115. Paging messages may be transmitted from the network entity 105-a (e.g., base station), a core network element, or both. In some aspects, paging messages may instruct the UE 115 to “wake up” or enter a different operational state. For example, UEs 115 may transition through various operational states (e.g., RRC_IDLE, RRC_INACTIVE) according to a discontinuous reception (DRX) cycle and in order to reduce power consumption.

In some cases, the network (e.g., network entity 105-a) may transmit a paging message to a UE 115 in an RRC idle or RRC inactive mode in order to initiate a connection setup in response to waiting message traffic or an incoming call for the UE 115. Additionally, or alternatively, the network entity 105 may transmit paging messages to inform UEs 115 about changes in system information, an emergency notification, an earthquake or tsunami warning notification, etc. The UEs 115 may be configured to monitor a paging CORESET (e.g., network-configured search space set for paging) to receive paging messages. Upon receiving a paging message, the UEs 115 may scan a PDCCH for scheduling messages (e.g., DCI), which may be indicated via CRC scrambled with P-RNTI. Subsequently, the UEs 115 may receive and decode the scheduled message traffic on PDSCH.

As noted previously herein, in some wireless communications systems, wireless devices (e.g., UEs 115) may be configured to monitor CORESETs to receive control information such as SIB messages and OSI messages. An initial CORESET0 may be configured for each UE 115 via a MIB, where the size and location of the CORESET0 is used to determine the initial BWP that each UE 115 is to monitor. For example, as shown in FIG. 2, the first UE 115-a, the second UE 115-b, or both, may be configured with a first CORESET 215-a (e.g., CORESET0), where the first CORESET 215-a is associated with an initial downlink BWP 220-a that the respective UEs 115 are to monitor for control information.

In some wireless communications systems, UEs 115 may be configured to receive SIB1, OSI 230, and paging messages within the initial downlink BWP 220-a. For example, the UE 115 may uses the initial downlink BWP 220-a defined by CORESET0 configuration in the MIB 210 to receive the SIB1. If the initial downlink BWP 220-a configured by the MIB 210 can be reconfigured in SIB1, the UE 115 may use the reconfigured initial downlink BWP 220-a for receiving OSI 230 and/or paging messages.

However, conventional CORESETs 215 and BWPs 220 generally span frequency ranges that are larger than those for which a RedCap UE 115 (e.g., first UE 115-a) is able to monitor. For example, in some cases, the first CORESET 215-a (and the initial downlink BWP 220-a) may span 20 MHz in the frequency domain. As a regular, as a full-capability wireless device (e.g., eMBB wireless device), the second UE 115-b may be able to monitor the first CORESET 215-a and BWP 220-a. However, as an eRedCap wireless device, the first UE 115-a may be able to monitor only up to 5 MHz, and may therefore be unable to monitor the first CORESET 215-a and/or BWP 220-a.

Accordingly, the wireless communications system 200 may support signaling, rules, and configurations for mapping sets of resources that are used to communicate SIBs, OSI, and paging messages for regular capacity UEs 115 to sets of resources that are able to be monitored by RedCap UEs 115. In particular, techniques described herein enable eRedCap UEs 115 to receive an indication of an initial BWP, and determine a sub-band within the initial BWP that will be used for receiving a SIB, as well as additional sub-bands that will be used for receiving OSI and paging messages.

For example, as shown in FIG. 2, the first UE 115-a may receive a first control message (e.g., MIB 210) indicating a first CORESET 215-a (e.g., CORESET0), the first downlink BWP 220-a associated with the first CORESET 215-a, or both. In some implementations, the first BWP 220-a may exceed a maximum bandwidth that is capable of being monitored by the first UE 115-a. For example, as an eRedCap UE 115-a, the first UE 115-a may be able to monitor up to 5 MHz, where the first BWP 220-a may span up to 20 MHz in the frequency domain.

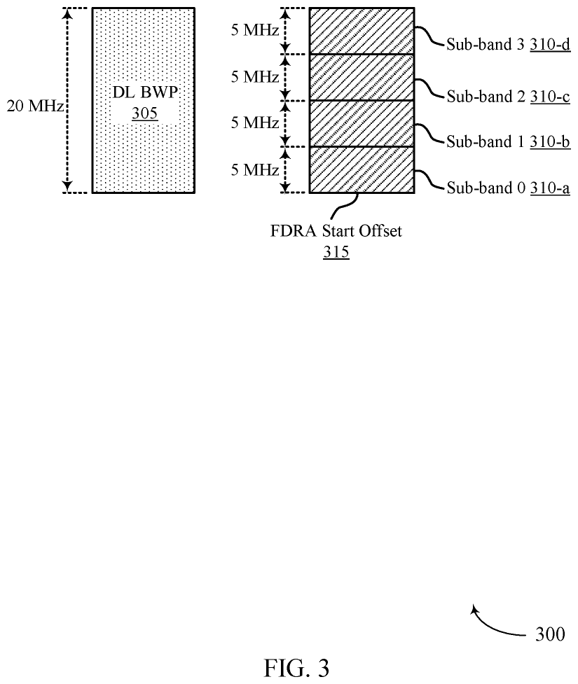

The first CORESET 215-a and the first BWP 220-a (e.g., initial BWP 220-a) may be further shown and described with reference to FIG. 3.

FIG. 3 illustrates an example of a resource configuration 300 that supports frequency resource configuration for system information and paging for eRedCap UEs in accordance with one or more aspects of the present disclosure. In some examples, aspects of the resource configuration 300 may implement, or be implemented by, aspects of the wireless communications system 100, the wireless communications system 200, or both.

The resource configuration 300 illustrates a downlink BWP 305, which may be an example of the first downlink BWP 220-a illustrated in FIG. 2. As shown in FIG. 3, the downlink BWP 305 (e.g., initial BWP 305) may span 20 MHz in the frequency domain. The frequency domain resource allocation (FDRA) start offset 315 associated with the BWP 305 may start from the first PRB of the BWP 305. In some aspects, the initial downlink BWP 305 may be determined by the location and size of the CORESET0 (e.g., CORESET 215-a in FIG. 2), which may be configured via a MIB message, reconfigured via a SIB message (e.g., SIB1), or both. For example, a MIB may indicate a PDCCH configuration for receiving SIB messages (e.g., pdcch-ConfigSIB1) that includes, or is associated with, the initial CORESET (e.g., CORESET0) and a search space configuration (e.g., search space 0 configuration).

In some aspects, the BWP 305 may span a set of sub-bands 310 in the frequency domain. For example, as shown in FIG. 3, the BWP 305 may span a first sub-band 310-a (e.g., sub-band 0), a second sub-band 310-b (e.g., sub-band 1), a third sub-band 310-c (e.g., sub-band 2), and a fourth sub-band 310-d (e.g., sub-band 3). In this example, each sub-band 310 may span 5 MHz in the frequency domain. In some implementations, the first UE 115-a and/or the network entity 105-a of the wireless communications system 200 illustrated in FIG. 2 may be configured to partition the configured downlink BWP 305 into the set of sub-bands 310. Each sub-band 310 may be associated with a corresponding sub-band identifier (sub-band ID).

Continuing with reference to the resource configuration 300, the start of each sub-band 310 may be determined with respect to the PRBO of the downlink BWP 305 and based on the SCS of the BWP 305. In other words, the start of the first sub-band 310-a may be based on the first resource block and the SCS of the BWP 305 associated with the CORESET associated with the BWP 305. Moreover, the start of each sub-band 310 in the frequency domain may be determined based on an offset relative to PRBO of the BWP 305. For instance, the first sub-band 310-a may be associated with a first FDRA start offset 0, the second sub-band 310-b may be associated with a second FDRA start offset 1, the third sub-band 310-c may be associated with a third FDRA start offset 2, and the fourth sub-band 310-d may be associated with a fourth FDRA start offset 3.

In some aspects, the offset for each sub-band 310 within the BWP 305 may be determined based on the maximum UE 115 bandwidth (e.g., largest bandwidth that the respective UE 115 is able to monitor). For example, offset k may be defined as k*N_{rb}, where N_{rb} is the number of resource blocks contained within maximum UE 115 bandwidth. A sub-band 310 may be considered to be valid if the respective sub-band contains a predefined number of resource blocks, such as N_{rb}. Additionally, the start of FDRA for downlink reception is the first resource block in a valid sub-band. In some cases, the offset k for the sub-bands 310 may be indicated via the MIB, and/or derived by some information in the MIB (e.g., by repurposing fields in the MIB, or by using reserved fields).

As noted previously herein, the BWP 305 may span a larger range of resources in the frequency domain than the first UE 115-a is able to monitor. That is, the first UE 115-a may only be able to monitor up to 5 MHz in the frequency domain, and may therefore be unable to monitor the entirety of the BWP 305 in the frequency domain. As such, in some implementations, the first UE 115-a may be configured to select a sub-band 310 from the BWP 305 that the UE 115-a will monitor for DCI messages used to schedule SIBs. In some aspects, the BWP 305 may be partitioned or sub-divided according to pre-defined rules, conditions, or configurations. For example, in some cases, the BWP 305 may be partitioned into sub-bands 310 of equal size in the frequency domain (e.g., equally partition the BWP 305 into sub-bands 310), such as according to the maximum bandwidth able to be monitored by the UE 115-a.

Reference will again be made to the wireless communications system 200 illustrated in FIG. 2. Upon being configured with the first CORESET 215-a and/or the first BWP 220-a, the first UE 115-a may select to monitor one of the sub-bands spanned by the BWP 220-a in the frequency domain. In other words, as shown in FIG. 3, the UE 115-a and the network entity 105-a may select or determine one of the sub-bands 310 spanned by the BWP 305 (e.g., BWP 220-a) that the UE 115-a is expected to monitor for control signaling used to schedule SIB1.

The UE 115-a and/or the network entity 105-a may determine which sub-band the UE 115-a is expected to select for SIB1 225 PDCCH monitoring (e.g., control signaling used to schedule the SIB1 225) may be based on a sub-band index associated with the respective sub-bands 310. For example, in some cases, the UE 115-a may be expected to select and monitor the sub-band 310 with the lowest or highest sub-band index. In this example, the sub-band that the UE 115-a is expected to monitor may be pre-defined, defined or signaled by the network entity 105-a, or both.

In some aspects, the sub-band index that is used to select the sub-band for SIB1 225 PDCCH monitoring may be determined based on (e.g., derived from) the SFN or slot index associated with the MIB 210. In particular, the MIB 210 may explicitly indicate the SFN or slot index. However, in some implementations, it may be undesirable to explicitly indicate the SFN and/or sub-band index within the MIB 210 due to the limited quantity of reserved bits within the MIB 210. As such, in additional or alternative implementations, the SFN and/or slot index may be derived based on a timing of the MIB 210.

Upon selecting a sub-band 310 from the BWP 305, 220-a, the UE 115-a may monitor the selected sub-band 310 for control signaling that schedules a SIB1. In some aspects, the sub-band for receiving the actual SIB1 225 may be explicitly indicated via the control message, the same sub-band for receiving the SIB1 225 PDCCH scheduling message, or both. In other words, the sub-band 310 for SIB1 225 PDSCH reception may be the same sub-band 310 within the BWP 220-a as was used to receive the control message that scheduled the SIB1 225. Additionally, or alternatively, the sub-band 310 for SIB1 PDSCH reception may be indicated via the control message that scheduled the SIB1. For example, the control message scheduling the SIB1 may include a DCI message, where the sub-band for receiving the SIB1 may be indicated in DCI 1_0 via a cyclic redundancy check portion of the DCI message scrambled by SI-RNTI (e.g., payload of SIB1 225 PDCCH). In this example, the SI-RNTI used to indicate the sub-band 310 for SIB1 225 reception may be an SI-RNTI associated with all UEs 115 within the network, a RedCap-specific (e.g., eRedCap-specific) SI-RNTI, or both.

Upon receiving the SIB1 225 within the first BWP 220-a, 305 (e.g., within a sub-band 310 of the BWP 220-a, 305), the UE 115-a may identify a sub-band 310 that will be used to receive control signaling that schedules additional system information (e.g., OSI 230). As noted previously herein, scheduling information for additional system information and/or the additional system information (e.g., OSI 230) itself may be received within a sub-band 310 of the first BWP 220-a and/or another BWP 220-b.

In some aspects, the sub-band 310 that is used to receive control signaling that schedules additional system information (e.g., OSI 230 PDCCH), the sub-band 310 that is used to receive the additional system information (e.g., OSI 230 PDSCH) itself, or both, may be explicitly indicated via the SIB1 225. The sub-band for OSI 230 PDCCH and/or PDSCH may or may not be included within the initial BWP 220-a that was used to receive the SIB1 225.

For example, in some cases, the SIB1 may indicate a single sub-band 310 that is to be used to receive control signaling that schedules OSI 230, and to receive the OSI 230 itself. In other words, the SIB1 225 may indicate a single sub-band that is used for OSI 230 PDCCH monitoring, and OSI 230 PDSCH monitoring. In additional or alternative cases, the sub-band 310 used to receive PDCCH with DCI scheduling the OSI 230 on the PDSCH may be different from the sub-band for UE 115 to receive PDSCH carrying the OSI 230. In other words, the SIB1 may indicate a first sub-band 310 that will be used by the UE 115-a to receive control signaling that schedules the OSI 230, and a second sub-band that will be used by the UE 115-a to receive the OSI 230 itself.

In some aspects, the sub-band 310 used to receive OSI 230 PDCCH and to receive OSI 230 PDSCH may be same sub-band 310 that is used by the UE 115-a to receive CORSET #0 and/or SIB1 225. In other words, in cases where the SIB1 225 does not indicate a new sub-band 310 that will be used to receive OSI 230 PDCCH and/or OSI 230 PDSCH, the UE 115-a may use the same sub-band 310 as was used to receive the SIB1 225 as a fallback option for receiving OSI 230 PDCCH and/or OSI 230 PDSCH (e.g., a fallback option if the sub-band 310 for UE 115-a to monitor the OSI 230 PDCCH and receive OSI 230 PDSCH is not explicitly indicated in SIB1 225).

In this regard, the UE 115-a may monitor a sub-band 310 for control signaling (e.g., PDCCH) that schedules additional system information (e.g., OSI 230) based on receiving the SIB1 225 within the BWP 220-a. In some aspects, the control signaling (e.g., DCI) that schedules the additional system information may include one or more fields that are used to indicate the sub-band 310 that will be used by the UE 115-a (e.g., eRedCap UE 115-a) to receive the additional system information (e.g., OSI 230).

Moreover, in some aspects, the UE 115-a may monitor the same or different sub-bands for paging messages. In some aspects, the sub-bands that will be used for transmitting/receiving paging messages 235, downlink messages indicated by paging messages 235, or both, may be explicitly indicated via the SIB1 225. Additionally, or alternatively, sub-bands that will be used for communicating paging messages may be indicated via paging tracking reference signals (TRSs), paging permanent equipment identifier (PEI) messages, a MIB (e.g., first control message), or any combination thereof.

In some aspects, the sub-band that the UE 115 monitors for paging messages 235 may be the same sub-band that is used to receive message traffic indicated by the paging messages 235. Additionally, or alternatively, the UE 115-a may monitor a first sub-band for paging messages 235, where the paging messages 235 (and/or SIB1 225) indicate a second sub-band that will be used to receive the message traffic. In cases where the SIB1 225 does not indicate a new sub-band that will be used to receive paging messages 235, the UE 115-a may monitor the same sub-band that was used to receive the SIB1 225 for paging messages 235. That is, the sub-band used to receive SIB1 225 may be a fallback option for receiving paging messages 235.

In some aspects, different sub-bands 310 may be used for different types of OSI 230 (e.g., different types of additional system information) and/or paging messages 235. In other words, the MIB 210, the SIB1 225, the OSI 230 PDCCH, or any combination thereof, may indicate different subsets of sub-bands 310 that may be used to receive different types of OSI 230, such as broadcast OSI 230, on-demand OSI 230, SIB2, SIB3, SIB4, etc. Stated differently, the SIB1 225 may indicate mapping relationships between sub-bands 310 and respective types of system information.

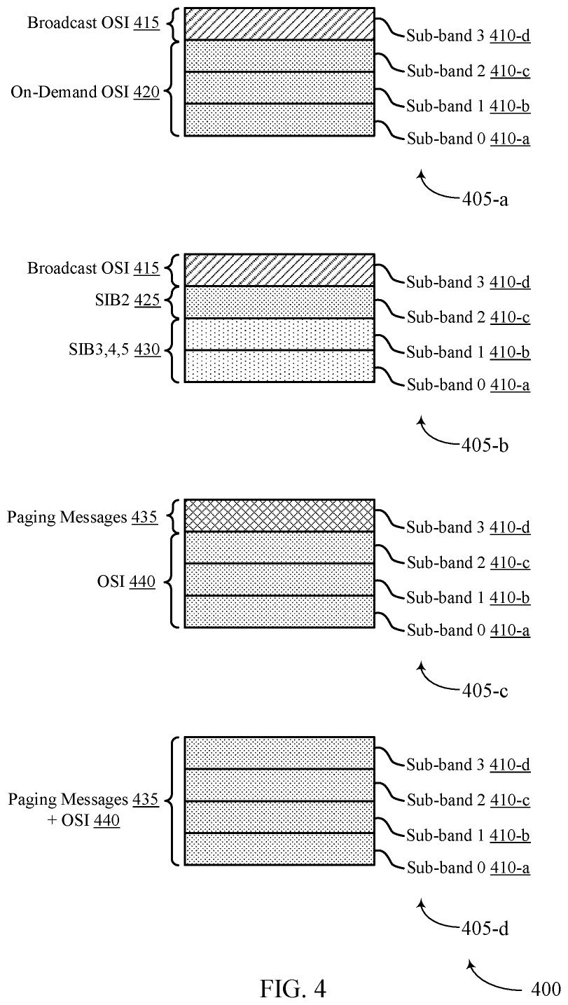

The concept of different subsets of sub-bands that are used for different types of additional system information (e.g., OSI 230) may be further shown and described with reference to FIG. 4.

FIG. 4 illustrates an example of a resource configuration 400 that supports frequency resource configuration for system information and paging for eRedCap UEs in accordance with one or more aspects of the present disclosure. In some examples, aspects of the resource configuration 400 may implement, or be implemented by, aspects of the wireless communications system 100, the wireless communications system 200, the resource configuration 300, or any combination thereof.

The resource configuration 400 illustrates different sub-band configurations 405 that allocate respective subsets of sub-bands 410 for receiving different types of OSI/additional system information. Each sub-band configuration 405 illustrates a set of sub-bands 410 including a first sub-band 410-a, a second sub-band 410-b, a third sub-band 410-c, and a fourth sub-band 410-d. In some cases, the sub-bands 410 illustrated in FIG. 4 may be examples of the sub-bands 310 illustrated in FIG. 3.

As noted previously herein, the subsets of sub-bands allocated for different types of information shown in the sub-band configurations 405 may be pre-configured, indicated via MIB, SSB, SIB1, OSI PDCCH, or any combination thereof.

Referring to the first sub-band configuration 405-a, the first sub-band 410-a, the second sub-band 410-b, and the third sub-band 410-c may be allocated for transmission/reception of on-demand OSI 420 (e.g., on-demand additional system information). Comparatively, the fourth sub-band 410-d may be allocated for transmission/reception of broadcast OSI 415. In this regard, the UE 115-a may be configured to monitor the fourth sub-band 410-d for broadcast OSI 415 without transmitting a request. Conversely, the UE 115-a may be expected to transmit a request for the on-demand OSI 420 that may be scheduled within the sub-bands 410-a, 410-b, and 410-c.

Referring now to the second sub-band configuration 405-b, the first sub-band 410-a and the second sub-band 410-b may be allocated for transmission/reception of additional SIBs 430 (e.g., SIB3, SIB4, SIB5, etc.). Comparatively, the third sub-band 410-c may be allocated for transmission/reception of SIB2 425, and the fourth sub-band 410-d may be allocated for transmission/reception of broadcast OSI 415. In this regard, different types or subsets of OSI (e.g., SIB2, SIB3, SIB4, SIB5) may be communicated on different subsets of sub-bands 410.

Referring now to the third sub-band configuration 405-c, the first sub-band 410-a, the second sub-band 410-b, and the third sub-band 410-c may be allocated for transmission/reception of OSI 440 (e.g., additional system information), including on-demand OSI, broadcast OSI, SIB2, SIB3, SIB4, etc. Comparatively, the fourth sub-band 410-d may be allocated for transmission/reception of paging messages 435. In this regard, different sub-bands may be used to communicate system information and paging information. Stated differently, the subset of sub-bands 410 for paging may not overlap with the subset of sub-bands 410 used for OSI.

Referring now to the fourth sub-band configuration 405-d, all the sub-bands 410-a, 410-b, 410-c, and 410-d may be used to communicate paging messages 435, OSI 440, or both. In this regard, the sub-bands 410 may include a set of common sub-bands 410 that may be used to deliver different types of additional system information, paging information, or both. Stated differently, the subset of sub-bands 410 for paging may at least partially overlap with the subset of sub-bands 410 used for OSI.

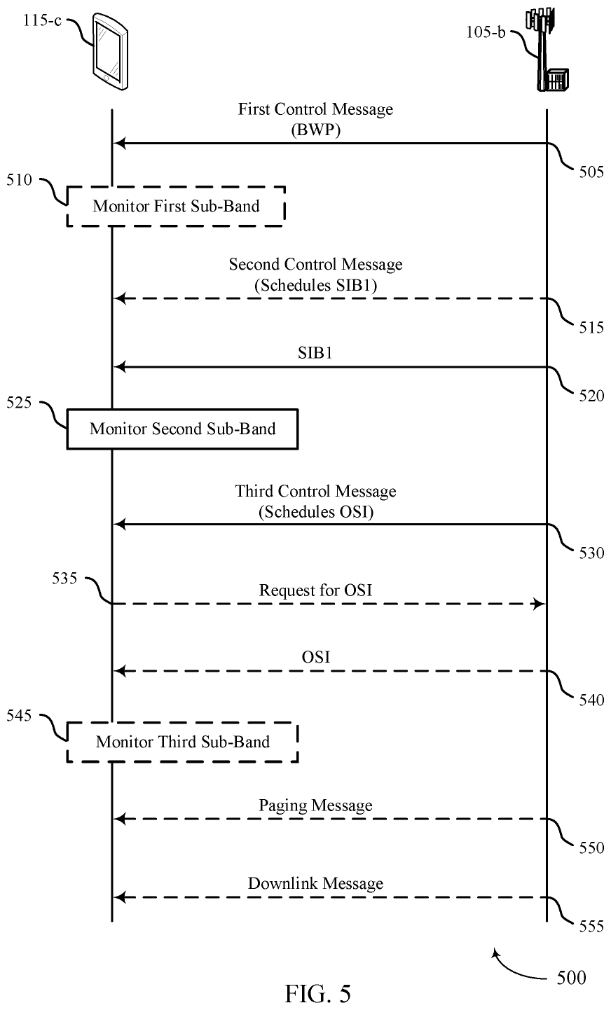

FIG. 5 illustrates an example of a process flow 500 that supports frequency resource configuration for system information and paging for eRedCap UEs in accordance with one or more aspects of the present disclosure. In some examples, aspects of the process flow 500 may implement, or be implemented by, aspects of the wireless communications system 100, the wireless communications system 200, the resource configuration 300, the resource configuration 400, or any combination thereof. In particular, the process flow 500 illustrates techniques that enable UEs 115, such as eRedCap UEs 115, to select a sub-bands that will be used to receive SIBs, OSI, and paging messages, as shown and described with reference to FIGS. 2-5.

The process flow 500 may include a UE 115-c and a network entity 105-b, which may be examples of UEs 115, network entities 105, and other wireless devices described with reference to FIGS. 1-3. For example, the UE 115-c and the network entity 105-b illustrated in FIG. 5 may include examples of the first UE 115-a and the network entity 105-a, respectively, as illustrated in FIG. 2. In this regard, the UE 115-c illustrated in FIG. 4 may be an example of an eRedCap UE 115.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-c may receive, from the network entity 105-b, a control message indicating a BWP spanning a set of sub-bands in the frequency domain. In some implementations, the control message may include a MIB, an SSB, or both. Moreover, in some aspects, the control message may indicate a CORESET associated with the BWP, where the CORESET may include an initial coreset (e.g., CORESET0) and the BWP associated with the CORESET may include an initial downlink BWP, as illustrated in FIGS. 2 and 3. In some aspects, the CORESET and/or BWP may span a set of resources in the frequency domain that exceeds a maximum bandwidth that the UE 115-c is able to monitor.

At 510, the UE 115-c may monitor a first sub-band within the BWP for control signaling that is used to schedule a SIB (e.g., SIB1). In this regard, the UE 115-c may monitor the first sub-band based on receiving the first control message at 505.

In some aspects, the UE 115-c and/or the network entity 105-b may select the first sub-band that will be used to receive/transmit control signaling used to schedule the SIB1 based on a sub-band index associated with the respective sub-band. For example, the UE 115-a may be configured to monitor the sub-band within the BWP with the highest or lowest sub-band index. In some cases, the sub-band index may be determined based on the first control message at 505. For example, in some cases, the MIB (e.g., first control message) may indicate an SFN or slot index that is used to determine the sub-band index. Additionally, or alternatively, the SFN or slot index may be derived from a relative timing of the first control message.

At 515, the UE 115-c may receive a second control message (e.g., PDCCH message, DCI) that schedules the UE 115-c to receive the SIB1. In particular, the UE 115-c may receive the second control message within the first sub-band. In this regard, the UE 115-c may receive the second control message at 515 based on receiving the first control message at 505, monitoring the first sub-band at 510, or both.

At 520, the UE 115-c may receive the SIB1. The UE 115-c may receive the SIB1 at 520 based on receiving the first control message at 505, monitoring the first sub-band at 510, receiving the second control message at 515, or any combination thereof.

In some aspects, sub-band that is used to receive the SIB1 at 520 may be the same or different as the first sub-band that was used to receive the SIB1 PDCCH at 515. For example, in some cases, the sub-band used to receive the SIB1 may be the same sub-band that was used to receive the second control message (e.g., first sub-band). In other cases, the second control message may indicate a different sub-band that will be used to communicate the SIB1. For example, a DCI message (e.g., second control message at 515) may indicate an additional sub-band that the UE 115-c is to monitor for the SIB1 via a CRC portion that is scrambled based on an SI-RNTI. As noted previously herein, in such cases, the SI-RNTI may be associated with regular, full-capability UEs 115, or may include an SI-RNTI that is dedicated for RedCap UEs 115 (e.g., eRedCap UEs 115).

At 525, the UE 115-c may monitor a second sub-band for control signaling that is used to schedule additional system information (e.g., OSI). The UE 115-c may monitor the second sub-band for PDCCH OSI (e.g., control signaling used to schedule OSI) based on receiving the SIB1 at 520.

In particular, in some implementations, the SIB1 may indicate the second sub-band that is to be monitored for control signaling used to schedule OSI (e.g., indicate the applicable sub-band index). In some cases, the indicated sub-band may be used for communicating both the PDCCH OSI and the PDSCH OSI. In other cases, the SIB1 may indicate separate sub-bands that will be used for PDCCH OSI and the PDSCH OSI. For instance, the SIB1 may indicate the second sub-band that will be monitored for control signaling used to schedule the OSI, and a third sub-band that is used for receiving the actual OSI.

In additional or alterative implementations, the SIB1 may not indicate a new sub-band that is to be used for receiving the PDCCH OSI and/or the PDSCH OSI. In such cases, the UE 115-c may be configured to monitor the same sub-band that was used to receive the CORESET0 and/or the SIB1 for the PDSCH OSI and/or the PDSCH OSI. In other words, in cases where the SIB1 does not indicate an additional sub-band for OSI, the absence of the additional sub-band indication may be interpreted as an implicit indication that the UE 115-c is to continue monitoring the first sub-band (e.g., select the first sub-band as the second sub-band) for control signaling used to schedule the OSI. For example, in cases where the SIB1 at 520 does not indicate an additional sub-band for PDCCH OSI, the UE 115-c may select and continue monitoring the first sub-band at 525 (e.g., select the first sub-band as the second sub-band) for control signaling used to schedule OSI.

At 530, the UE 115-c may receive a third control message (e.g., DCI) that schedules the UE 115-c to receive additional system information (e.g., OSI). The UE 115-c may receive the third control message at 530 based on receiving the first control message at 505, receiving the second control message at 515, receiving the SIB1 at 520, monitoring the selected sub-band at 525, or any combination thereof.

In some implementations, the third control message may indicate a sub-band(s) that the UE 115-c may monitor to receive OSI. Additionally, the third control message may indicate sub-bands associated with different types of OSI. Moreover, the third control message may indicate a respective type of OSI for each OSI message (e.g., first OSI message includes a broadcast OSI, second OSI message includes an on-demand OSI).

For example, as shown and described in FIG. 4, the third control message may indicate different subsets of sub-band that are used to communicate different types of OSI and/or paging messages. For instance, the third control message may indicate a first subset of sub-bands associated with broadcast OSI, a second subset of sub-bands associated with on-demand OSI, a third subset of sub-bands associated with SIB2, SIB3, SIB4, and a fourth subset of sub-bands associated with paging messages.

As noted previously herein, the respective subsets of sub-bands may or may not overlap with one another. In other words, the third control message may indicate a common set of sub-bands that may be used to deliver broadcast OSI, on-demand OSI, SIB2/SIB3/SIB4/SIB5, paging messages, or any combination thereof.

At 535, the UE 115-c may transmit a request for on-demand additional system information (e.g., on-demand OSI). In particular, the UE 115-c may transmit the request at 535 based on receiving an indication that the additional system information includes an on-demand OSI.

In the case of on-demand OSI, the third control signaling may indicate resources (e.g., sub-bands) that are to be used by the UE 115-c to transmit requests for on-demand OSI. Additionally, or alternatively, the third control message may indicate a relationship or other configuration between the resources (e.g., sub-bands) on which on-demand OSI will be communicated, and the resources (e.g., sub-bands) on which requests for on-demand OSI are to be communicated.

At 540, the UE 115-c may receive the additional system information (e.g., OSI) from the network entity 105-b. The UE 115-c may receive the OSI at 540 based on receiving the first control message at 505, receiving the second control message at 515, receiving the SIB1 at 520, monitoring the selected sub-band at 525, receiving the third control message at 530, transmitting the request for the OSI at 535, or any combination thereof. As noted previously herein, the OSI may be received at 540 via the same or different sub-band used to receive the third control message at 530. The sub-band for the OSI may be indicated via the SIB1 at 520, via the third control message at 530, or both.

At 545, the UE 115-c may monitor a third sub-band for paging messages. As noted previously herein, the UE 115-c may monitor the same or different sub-bands for paging messages as compared to the sub-bands for OSI. In this regard, the third sub-band illustrated in FIG. 5 may be the same or different sub-band as compared to the first sub-band monitored at 510, the second sub-band monitored at 525, or both.

In some aspects, the sub-bands that will be used for transmitting/receiving paging messages 235, downlink messages indicated by paging messages 235, or both, may be explicitly indicated via the SIB1 225. Additionally, or alternatively, sub-bands that will be used for communicating paging messages may be indicated via paging TRSs, paging PEI messages, a MIB (e.g., first control message), or any combination thereof.

At 550, the UE 115-c may receive a paging message from the network entity 105-b. In particular, the UE 115-c may receive a paging message via the third sub-band that was monitored at 545. The paging message may indicate that there is message traffic waiting to be delivered to the UE 115-c. In this regard, the paging message may schedule the UE 115-a to receive a downlink message (e.g., paging PDSCH). In some aspects, the paging PDCCH message may include a field that is used to indicate a sub-band for receiving the downlink message.

At 555, the UE 115-c may receive a downlink message (e.g., paging PDSCH) from the network entity 105-b. In particular, the UE 115-c may receive the downlink message at 555 based on receiving the paging message at 550. For example, the UE 115-c may receive the downlink message within a sub-band indicated via the paging message.

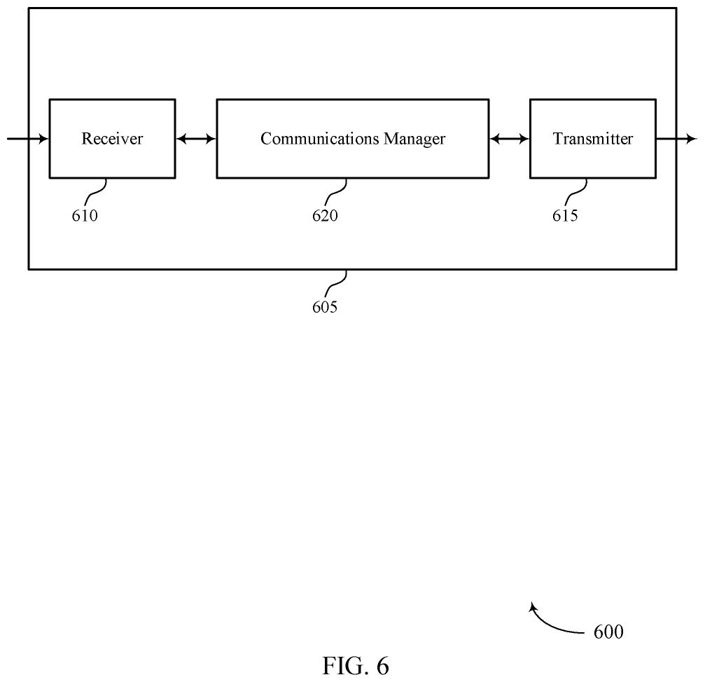

FIG. 6 shows a block diagram 600 of a device 605 that supports frequency resource configuration for system information and paging for eRedCap UEs in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to frequency resource configuration for system information and paging for eRedCap UEs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to frequency resource configuration for system information and paging for eRedCap UEs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of frequency resource configuration for system information and paging for eRedCap UEs as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving a first control message indicating a downlink BWP spanning a set of multiple sub-bands in a frequency domain. The communications manager 620 may be configured as or otherwise support a means for receiving a SIB within a first sub-band selected from the set of multiple sub-bands based on a sub-band index associated with the first sub-band. The communications manager 620 may be configured as or otherwise support a means for monitoring, based on the SIB, a second sub-band for control signaling that schedules the UE to receive additional system information. The communications manager 620 may be configured as or otherwise support a means for receiving a second control message within the second sub-band based on monitoring the second sub-band, the second control message scheduling the UE to receive the additional system information.

By including or configuring the communications manager 620 in accordance with examples as described herein, the device 605 (e.g., a processor controlling or otherwise coupled with the receiver 610, the transmitter 615, the communications manager 620, or a combination thereof) may support techniques that enable eRedCap UEs 115 to be configured with CORESETs and/or BWPs capable of being monitored by regular, full-capability UEs 115 and identify CORESETs/BWPs that are capable of being monitored by eRedCap UEs 115 for receiving SIBs, OSI, paging messages, or any combination thereof. As such, aspects of the present disclosure may enable traditional control signaling used to configure CORESETs/BWPs for regular-capacity UEs 115 to be used to configure CORESETs/BWPs for eRedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 for receiving OSI and paging messages so that the RedCap UEs 115 and the network can be in sync with one another with respect to which resources will be used to communicate such messages. As such, techniques described herein may improve an efficiency and reliability of wireless communications between RedCap UEs 115 and the network.

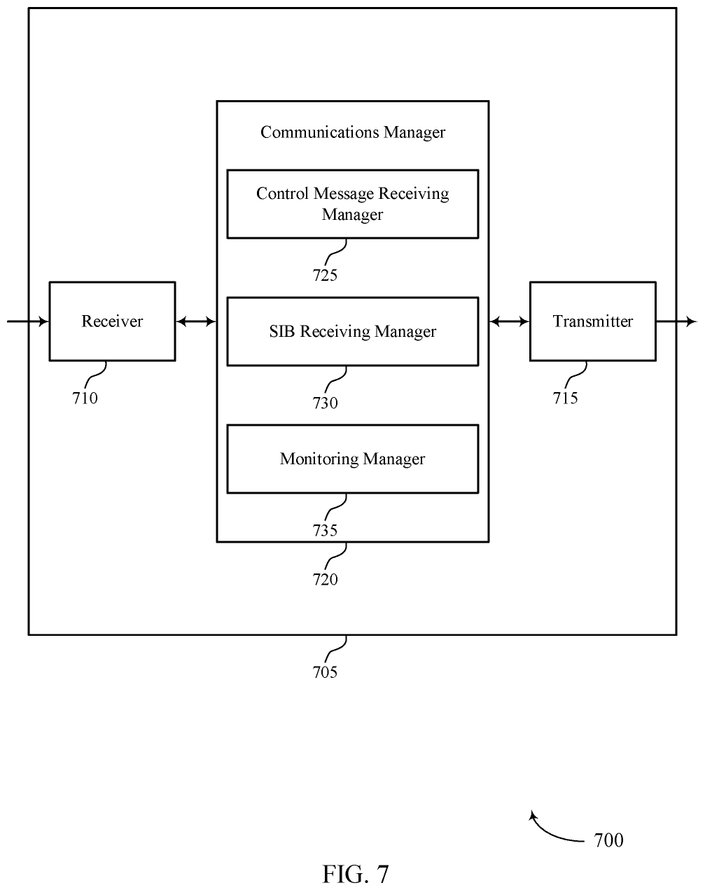

FIG. 7 shows a block diagram 700 of a device 705 that supports frequency resource configuration for system information and paging for eRedCap UEs in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to frequency resource configuration for system information and paging for eRedCap UEs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to frequency resource configuration for system information and paging for eRedCap UEs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of frequency resource configuration for system information and paging for eRedCap UEs as described herein. For example, the communications manager 720 may include a control message receiving manager 725, an SIB receiving manager 730, a monitoring manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The control message receiving manager 725 may be configured as or otherwise support a means for receiving a first control message indicating a downlink BWP spanning a set of multiple sub-bands in a frequency domain. The SIB receiving manager 730 may be configured as or otherwise support a means for receiving a SIB within a first sub-band selected from the set of multiple sub-bands based on a sub-band index associated with the first sub-band. The monitoring manager 735 may be configured as or otherwise support a means for monitoring, based on the SIB, a second sub-band for control signaling that schedules the UE to receive additional system information. The control message receiving manager 725 may be configured as or otherwise support a means for receiving a second control message within the second sub-band based on monitoring the second sub-band, the second control message scheduling the UE to receive the additional system information.

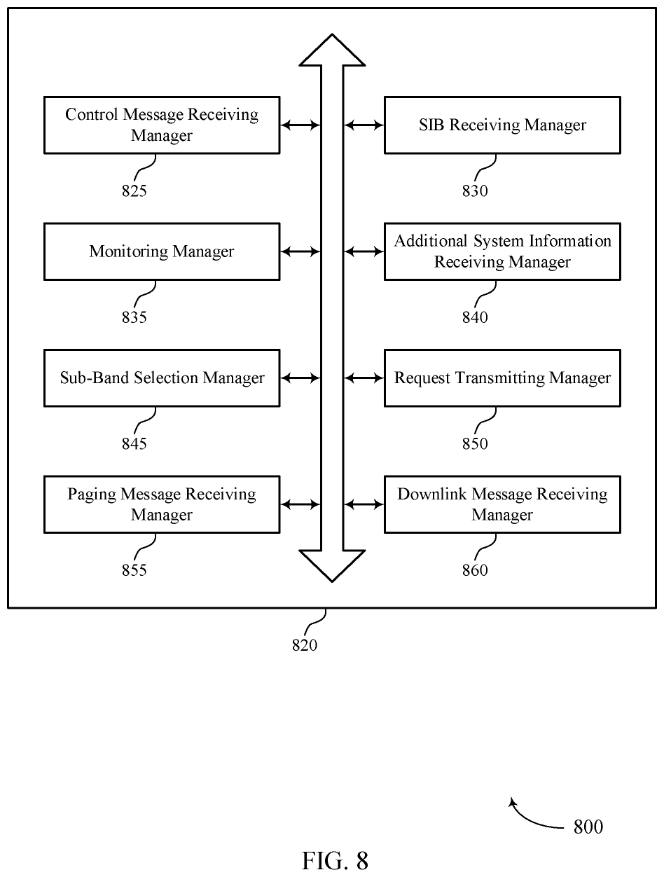

FIG. 8 shows a block diagram 800 of a communications manager 820 that supports frequency resource configuration for system information and paging for eRedCap UEs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of frequency resource configuration for system information and paging for eRedCap UEs as described herein. For example, the communications manager 820 may include a control message receiving manager 825, an SIB receiving manager 830, a monitoring manager 835, an additional system information receiving manager 840, a sub-band selection manager 845, a request transmitting manager 850, a paging message receiving manager 855, a downlink message receiving manager 860, or any combination thereof. Each of these components may communicate, directly or indirectly, with one another (e.g., via one or more buses).

The communications manager 820 may support wireless communication at a UE in accordance with examples as disclosed herein. The control message receiving manager 825 may be configured as or otherwise support a means for receiving a first control message indicating a downlink BWP spanning a set of multiple sub-bands in a frequency domain. The SIB receiving manager 830 may be configured as or otherwise support a means for receiving a SIB within a first sub-band selected from the set of multiple sub-bands based on a sub-band index associated with the first sub-band. The monitoring manager 835 may be configured as or otherwise support a means for monitoring, based on the SIB, a second sub-band for control signaling that schedules the UE to receive additional system information. In some examples, the control message receiving manager 825 may be configured as or otherwise support a means for receiving a second control message within the second sub-band based on monitoring the second sub-band, the second control message scheduling the UE to receive the additional system information.

In some examples, the SIB receiving manager 830 may be configured as or otherwise support a means for receiving, via the SIB, an indication of the second sub-band, where receiving the second control message is based on receiving the indication of the second sub-band. In some examples, the additional system information receiving manager 840 may be configured as or otherwise support a means for receiving the additional system information via the second sub-band based on receiving the indication of the second sub-band.

In some examples, the SIB receiving manager 830 may be configured as or otherwise support a means for receiving, via the SIB, an indication of the second sub-band and an indication of a third sub-band, where receiving the second control message is based on receiving the indication of the second sub-band. In some examples, the additional system information receiving manager 840 may be configured as or otherwise support a means for receiving the additional system information via the third sub-band based on receiving the indication of the third sub-band.

In some examples, the sub-band selection manager 845 may be configured as or otherwise support a means for selecting the first sub-band as the second sub-band based on an absence of an indication of an additional sub-band within the SIB, where the second control message is received within the first sub-band based on the selecting.

In some examples, the additional system information receiving manager 840 may be configured as or otherwise support a means for receiving the additional system information via the first sub-band based on selecting the first sub-band as the second sub-band, based on receiving the second control message via the first sub-band, or both.

In some examples, the control message receiving manager 825 may be configured as or otherwise support a means for receiving a third control message that schedules the SIB within the first sub-band of the set of multiple sub-bands. In some examples, the monitoring manager 835 may be configured as or otherwise support a means for monitoring the first sub-band for the SIB based on receiving the third control message via the first sub-band, where receiving the SIB is based on the monitoring.

In some examples, the control message receiving manager 825 may be configured as or otherwise support a means for receiving a third control message that schedules the SIB, the third control message including an indication of the first sub-band. In some examples, the monitoring manager 835 may be configured as or otherwise support a means for monitoring the first sub-band for the SIB based on receiving the indication of the first sub-band, where receiving the SIB is based on the monitoring.

In some examples, the indication of the first sub-band includes a CRC portion of the third control message that is scrambled based on an SI-RNTI. In some examples, the information radio network temporary identifier is associated with eRedCap UEs. In some examples, the UE includes an eRedCap UE.

In some examples, the control message receiving manager 825 may be configured as or otherwise support a means for receiving, via the second control message, an indication of a third sub-band for receiving the additional system information, where the third sub-band is the same or different as the first sub-band, the second sub-band, or both. In some examples, the additional system information receiving manager 840 may be configured as or otherwise support a means for receiving the additional system information within the third sub-band based on receiving the indication of the third sub-band.

In some examples, the control message receiving manager 825 may be configured as or otherwise support a means for receiving, via the second control message, an indication of a first subset of sub-bands associated with broadcast system information, and an indication of a second subset of sub-bands associated with on-demand system information, the second subset of sub-bands different from the first subset of sub-bands, where the second sub-band is included within the first subset of sub-bands if the additional system information includes broadcast system information, or where the second sub-band is included within the second subset of sub-bands if the additional system information includes on-demand system information.

In some examples, the request transmitting manager 850 may be configured as or otherwise support a means for transmitting, based on the second control message, a request for the additional system information based on the additional system information including on-demand system information. In some examples, the additional system information receiving manager 840 may be configured as or otherwise support a means for receiving the additional system information within the second sub-band based on the request.

In some examples, the control message receiving manager 825 may be configured as or otherwise support a means for receiving, via the second control message, an indication of a first subset of sub-bands associated with a first type of additional system information, and an indication of a second subset of sub-bands associated with a second type of additional system information, the second subset of sub-bands different from the first subset of sub-bands, where the second sub-band is included within the first subset of sub-bands if the additional system information is of the first type, or where the second sub-band is included within the second subset of sub-bands if the additional system information is of the second type.

In some examples, the control message receiving manager 825 may be configured as or otherwise support a means for receiving an indication of a common set of sub-bands associated with broadcast system information, on-demand system information, a first type of additional system information, a second type of additional system information, or any combination thereof.

In some examples, the sub-band selection manager 845 may be configured as or otherwise support a means for selecting a third sub-band of the set of multiple sub-bands based on an additional sub-band index associated with the third sub-band, where the third sub-band is the same or different as the first sub-band, the second sub-band, or both. In some examples, the control message receiving manager 825 may be configured as or otherwise support a means for receiving a third control message within the third sub-band, where the third control message schedules the UE to receive the SIB.

In some examples, each sub-band of the set of multiple sub-bands is associated with a respective sub-band index, and the sub-band selection manager 845 may be configured as or otherwise support a means for selecting the third sub-band based on the additional sub-band index associated with the third sub-band including a highest sub-band index of the set of multiple sub-band indices, or based on the additional sub-band index including a lowest sub-band index of the set of multiple sub-band indices.

In some examples, the sub-band selection manager 845 may be configured as or otherwise support a means for determining the additional sub-band index associated with the third sub-band based on an SFN, a slot index, or both, where the SFN, the slot index, or both, are indicated via the first control message, determined based on a timing of the first control message, or both. In some examples, selecting the sub-band of the set of multiple sub-bands is based on the UE including an eRedCap UE.

In some examples, the control message receiving manager 825 may be configured as or otherwise support a means for receiving, via the first control message, the second control message, a paging TRS, paging PEI message, or any combination thereof, an indication of a third sub-band associated with paging resources for the UE, where the third sub-band is the same or different as the first sub-band, the second sub-band, or both. In some examples, the monitoring manager 835 may be configured as or otherwise support a means for monitoring the third sub-band for a paging message based on receiving the indication of the third sub-band.

In some examples, the paging message receiving manager 855 may be configured as or otherwise support a means for receiving the paging message based on monitoring the third sub-band, where the paging message schedules the UE to receive a downlink message within a fourth sub-band, where the fourth sub-band is the same or different as the first sub-band, the second sub-band, the third sub-band, or any combination thereof. In some examples, the downlink message receiving manager 860 may be configured as or otherwise support a means for receiving the downlink message within the fourth sub-band based on the paging message.

In some examples, the second sub-band used to receive the second control message that schedules the additional system information is included within a first subset of the set of multiple sub-bands. In some examples, the third sub-band used to receive the paging message is included within a second subset of the set of multiple sub-bands that is different from the first subset.

In some examples, the first control message includes a MIB. In some examples, the second sub-band is included within the set of multiple sub-bands spanned by the downlink BWP.

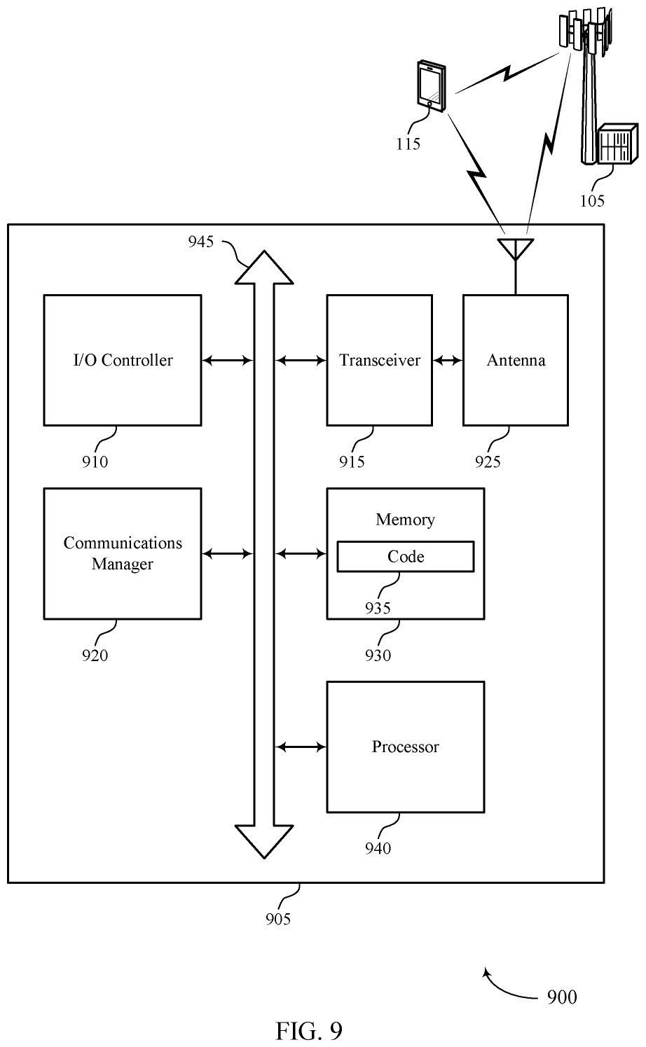

FIG. 9 shows a diagram of a system 900 including a device 905 that supports frequency resource configuration for system information and paging for eRedCap UEs in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting frequency resource configuration for system information and paging for eRedCap UEs). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving a first control message indicating a downlink BWP spanning a set of multiple sub-bands in a frequency domain. The communications manager 920 may be configured as or otherwise support a means for receiving a SIB within a first sub-band selected from the set of multiple sub-bands based on a sub-band index associated with the first sub-band. The communications manager 920 may be configured as or otherwise support a means for monitoring, based on the SIB, a second sub-band for control signaling that schedules the UE to receive additional system information. The communications manager 920 may be configured as or otherwise support a means for receiving a second control message within the second sub-band based on monitoring the second sub-band, the second control message scheduling the UE to receive the additional system information.

By including or configuring the communications manager 920 in accordance with examples as described herein, the device 905 may support techniques that enable eRedCap UEs 115 to be configured with CORESETs and/or BWPs capable of being monitored by regular, full-capability UEs 115 and identify CORESETs/BWPs that are capable of being monitored by eRedCap UEs 115 for receiving SIBs, OSI, paging messages, or any combination thereof. As such, aspects of the present disclosure may enable traditional control signaling used to configure CORESETs/BWPs for regular-capacity UEs 115 to be used to configure CORESETs/BWPs for eRedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 for receiving OSI and paging messages so that the RedCap UEs 115 and the network can be in sync with one another with respect to which resources will be used to communicate such messages. As such, techniques described herein may improve an efficiency and reliability of wireless communications between RedCap UEs 115 and the network.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of frequency resource configuration for system information and paging for eRedCap UEs as described herein, or the processor 940 and the memory 930 may be otherwise configured to perform or support such operations.

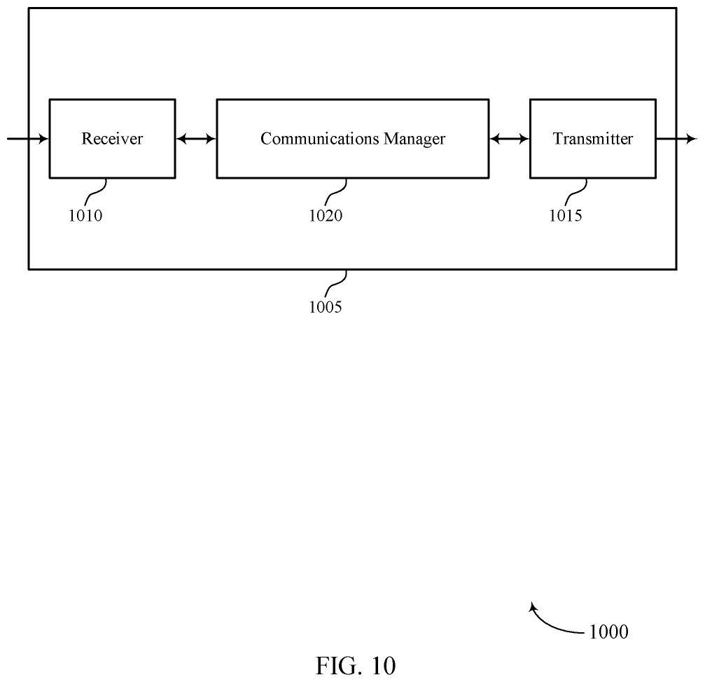

FIG. 10 shows a block diagram 1000 of a device 1005 that supports frequency resource configuration for system information and paging for eRedCap UEs in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of frequency resource configuration for system information and paging for eRedCap UEs as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting, to a UE, a first control message indicating a downlink BWP spanning a set of multiple sub-bands in a frequency domain. The communications manager 1020 may be configured as or otherwise support a means for transmitting a SIB to the UE within a first sub-band selected from the set of multiple sub-bands based on a sub-band index associated with the first sub-band. The communications manager 1020 may be configured as or otherwise support a means for transmitting a second control message to the UE within the second sub-band, where the second sub-band is based on the SIB, and where the second control message schedules the UE to receive additional system information.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques that enable eRedCap UEs 115 to be configured with CORESETs and/or BWPs capable of being monitored by regular, full-capability UEs 115 and identify CORESETs/BWPs that are capable of being monitored by eRedCap UEs 115 for receiving SIBs, OSI, paging messages, or any combination thereof. As such, aspects of the present disclosure may enable traditional control signaling used to configure CORESETs/BWPs for regular-capacity UEs 115 to be used to configure CORESETs/BWPs for eRedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 for receiving OSI and paging messages so that the RedCap UEs 115 and the network can be in sync with one another with respect to which resources will be used to communicate such messages. As such, techniques described herein may improve an efficiency and reliability of wireless communications between RedCap UEs 115 and the network.

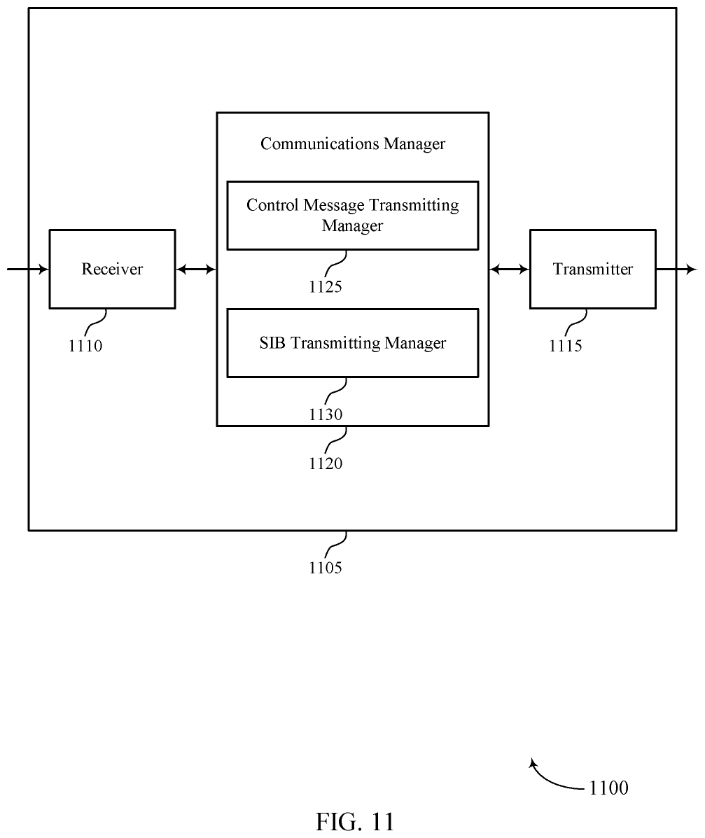

FIG. 11 shows a block diagram 1100 of a device 1105 that supports frequency resource configuration for system information and paging for eRedCap UEs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of frequency resource configuration for system information and paging for eRedCap UEs as described herein. For example, the communications manager 1120 may include a control message transmitting manager 1125 an SIB transmitting manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The control message transmitting manager 1125 may be configured as or otherwise support a means for transmitting, to a UE, a first control message indicating a downlink BWP spanning a set of multiple sub-bands in a frequency domain. The SIB transmitting manager 1130 may be configured as or otherwise support a means for transmitting a SIB to the UE within a first sub-band selected from the set of multiple sub-bands based on a sub-band index associated with the first sub-band. The control message transmitting manager 1125 may be configured as or otherwise support a means for transmitting a second control message to the UE within the second sub-band, where the second sub-band is based on the SIB, and where the second control message schedules the UE to receive additional system information.

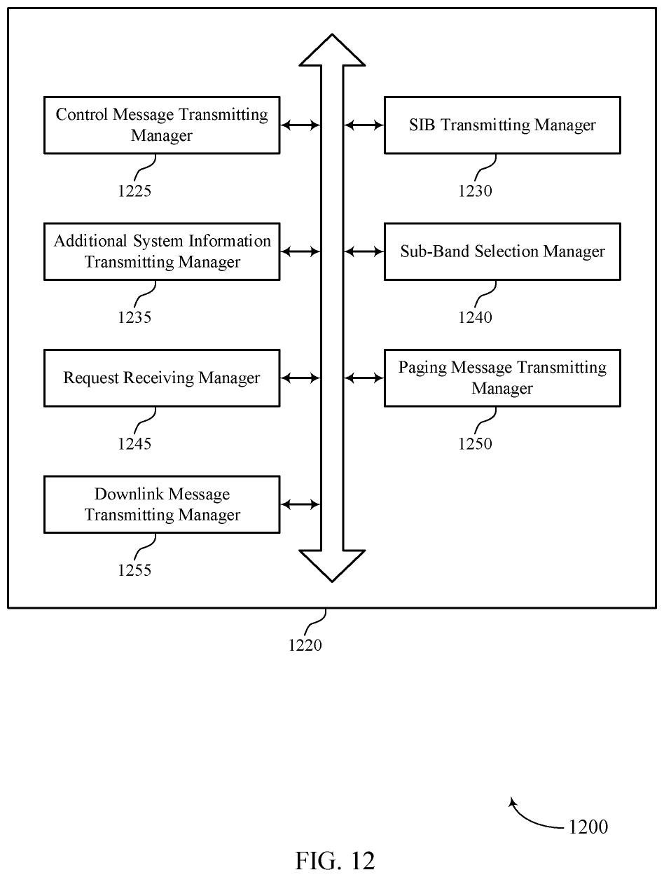

FIG. 12 shows a block diagram 1200 of a communications manager 1220 that supports frequency resource configuration for system information and paging for eRedCap UEs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of frequency resource configuration for system information and paging for eRedCap UEs as described herein. For example, the communications manager 1220 may include a control message transmitting manager 1225, an SIB transmitting manager 1230, an additional system information transmitting manager 1235, a sub-band selection manager 1240, a request receiving manager 1245, a paging message transmitting manager 1250, a downlink message transmitting manager 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The control message transmitting manager 1225 may be configured as or otherwise support a means for transmitting, to a UE, a first control message indicating a downlink BWP spanning a set of multiple sub-bands in a frequency domain. The SIB transmitting manager 1230 may be configured as or otherwise support a means for transmitting a SIB to the UE within a first sub-band selected from the set of multiple sub-bands based on a sub-band index associated with the first sub-band. In some examples, the control message transmitting manager 1225 may be configured as or otherwise support a means for transmitting a second control message to the UE within the second sub-band, where the second sub-band is based on the SIB, and where the second control message schedules the UE to receive additional system information.

In some examples, the SIB transmitting manager 1230 may be configured as or otherwise support a means for transmitting, via the SIB, an indication of the second sub-band, where transmitting the second control message is based on transmitting the indication of the second sub-band. In some examples, the additional system information transmitting manager 1235 may be configured as or otherwise support a means for transmitting the additional system information via the second sub-band based on transmitting the indication of the second sub-band.

In some examples, the SIB transmitting manager 1230 may be configured as or otherwise support a means for transmitting, via the SIB, an indication of the second sub-band and an indication of a third sub-band, where transmitting the second control message is based on transmitting the indication of the second sub-band. In some examples, the additional system information transmitting manager 1235 may be configured as or otherwise support a means for transmitting the additional system information via the third sub-band based on transmitting the indication of the third sub-band.

In some examples, the sub-band selection manager 1240 may be configured as or otherwise support a means for selecting the first sub-band as the second sub-band based on an absence of an indication of an additional sub-band within the SIB, where the second control message is transmitted within the first sub-band based on the selecting.

In some examples, the additional system information transmitting manager 1235 may be configured as or otherwise support a means for transmitting the additional system information via the first sub-band based on selecting the first sub-band as the second sub-band, based on transmitting the second control message via the first sub-band, or both.

In some examples, the control message transmitting manager 1225 may be configured as or otherwise support a means for transmitting a third control message that schedules the SIB within the first sub-band of the set of multiple sub-bands, where transmitting the SIB is based on the third control message. In some examples, the control message transmitting manager 1225 may be configured as or otherwise support a means for transmitting a third control message that schedules the SIB, the third control message including an indication of the first sub-band, where transmitting the SIB is based on the third control message.

In some examples, the indication of the first sub-band includes a CRC portion of the third control message that is scrambled based on an SI-RNTI. In some examples, the information radio network temporary identifier is associated with eRedCap UEs. In some examples, the UE includes an eRedCap UE.

In some examples, the control message transmitting manager 1225 may be configured as or otherwise support a means for transmitting, via the second control message, an indication of a third sub-band for transmitting the additional system information, where the third sub-band is the same or different as the first sub-band, the second sub-band, or both. In some examples, the additional system information transmitting manager 1235 may be configured as or otherwise support a means for transmitting the additional system information to the UE within the third sub-band based on transmitting the indication of the third sub-band.

In some examples, the control message transmitting manager 1225 may be configured as or otherwise support a means for transmitting, via the second control message, an indication of a first subset of sub-bands associated with broadcast system information, and an indication of a second subset of sub-bands associated with on-demand system information, the second subset of sub-bands different from the first subset of sub-bands, where the second sub-band is included within the first subset of sub-bands if the additional system information includes broadcast system information, or where the second sub-band is included within the second subset of sub-bands if the additional system information includes on-demand system information.

In some examples, the request receiving manager 1245 may be configured as or otherwise support a means for receiving, from the UE based on the second control message, a request for the additional system information based on the additional system information including on-demand system information. In some examples, the additional system information transmitting manager 1235 may be configured as or otherwise support a means for transmitting the additional system information within the second sub-band based on the request.

In some examples, the control message transmitting manager 1225 may be configured as or otherwise support a means for transmitting, via the second control message, an indication of a first subset of sub-bands associated with a first type of additional system information, and an indication of a second subset of sub-bands associated with a second type of additional system information, the second subset of sub-bands different from the first subset of sub-bands, where the second sub-band is included within the first subset of sub-bands if the additional system information includes the first type, or where the second sub-band is included within the second subset of sub-bands if the additional system information includes the second type.

In some examples, the sub-band selection manager 1240 may be configured as or otherwise support a means for selecting a third sub-band of the set of multiple sub-bands based on an additional sub-band index associated with the third sub-band, where the third sub-band is the same or different as the first sub-band, the second sub-band, or both. In some examples, the control message transmitting manager 1225 may be configured as or otherwise support a means for transmitting a third control message from the network entity within the third sub-band, where the third control message schedules the UE to receive the SIB.

In some examples, each sub-band of the set of multiple sub-bands is associated with a respective sub-band index, and the sub-band selection manager 1240 may be configured as or otherwise support a means for selecting the third sub-band based on the additional sub-band index associated with the third sub-band including a highest sub-band index of the set of multiple sub-band indices, or based on the additional sub-band index including a lowest sub-band index of the set of multiple sub-band indices.

In some examples, the sub-band selection manager 1240 may be configured as or otherwise support a means for determining the additional sub-band index associated with the third sub-band based on an SFN, a slot index, or both, where the SFN, the slot index, or both, are indicated via the first control message, determined based on a timing of the first control message, or both. In some examples, selecting the sub-band of the set of multiple sub-bands is based on the UE including an eRedCap UE.

In some examples, the control message transmitting manager 1225 may be configured as or otherwise support a means for transmitting, via the first control message, the second control message, a paging TRS, paging PEI message, or any combination thereof, an indication of a third sub-band associated with paging resources for the UE, where the third sub-band is the same or different as the first sub-band, the second sub-band, or both.

In some examples, the paging message transmitting manager 1250 may be configured as or otherwise support a means for transmitting the paging message based within the third sub-band based on the indication of the third sub-band, where the paging message schedules the UE to receive a downlink message within a fourth sub-band, where the fourth sub-band is the same or different as the first sub-band, the second sub-band, the third sub-band, or any combination thereof. In some examples, the downlink message transmitting manager 1255 may be configured as or otherwise support a means for transmitting the downlink message to the UE within the fourth sub-band based on the paging message.

In some examples, the second sub-band used to transmit the second control message that schedules the additional system information is included within a first subset of the set of multiple sub-bands. In some examples, the third sub-band used to transmit the paging message is included within a second subset of the set of multiple sub-bands that is different from the first subset.

In some examples, the first control message includes a MIB. In some examples, the second sub-band is included within the set of multiple sub-bands spanned by the downlink BWP.

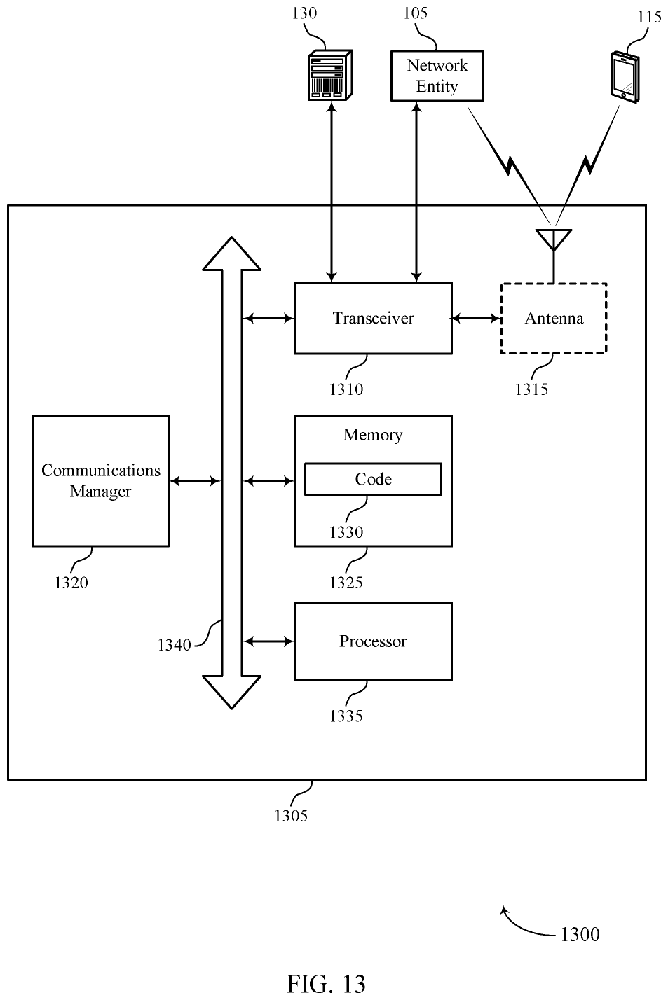

FIG. 13 shows a diagram of a system 1300 including a device 1305 that supports frequency resource configuration for system information and paging for eRedCap UEs in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting frequency resource configuration for system information and paging for eRedCap UEs). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting, to a UE, a first control message indicating a downlink BWP spanning a set of multiple sub-bands in a frequency domain. The communications manager 1320 may be configured as or otherwise support a means for transmitting a SIB to the UE within a first sub-band selected from the set of multiple sub-bands based on a sub-band index associated with the first sub-band. The communications manager 1320 may be configured as or otherwise support a means for transmitting a second control message to the UE within the second sub-band, where the second sub-band is based on the SIB, and where the second control message schedules the UE to receive additional system information.

By including or configuring the communications manager 1320 in accordance with examples as described herein, the device 1305 may support techniques that enable eRedCap UEs 115 to be configured with CORESETs and/or BWPs capable of being monitored by regular, full-capability UEs 115 and identify CORESETs/BWPs that are capable of being monitored by eRedCap UEs 115 for receiving SIBs, OSI, paging messages, or any combination thereof. As such, aspects of the present disclosure may enable traditional control signaling used to configure CORESETs/BWPs for regular-capacity UEs 115 to be used to configure CORESETs/BWPs for eRedCap UEs 115, such as eRedCap UEs 115. As such, techniques described herein may reduce control signaling used to configure CORESETs and BWPs for regular, full-capability UEs 115 and RedCap UEs 115. Moreover, aspects of the present disclosure provide for rules, conditions, and configurations for selecting/identifying resources that will be monitored by RedCap UEs 115 for receiving OSI and paging messages so that the RedCap UEs 115 and the network can be in sync with one another with respect to which resources will be used to communicate such messages. As such, techniques described herein may improve an efficiency and reliability of wireless communications between RedCap UEs 115 and the network.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of frequency resource configuration for system information and paging for eRedCap UEs as described herein, or the processor 1335 and the memory 1325 may be otherwise configured to perform or support such operations.

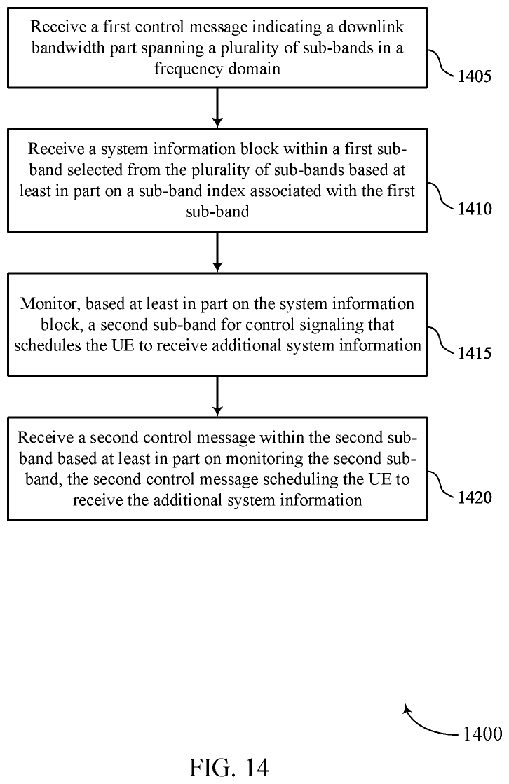

FIG. 14 shows a flowchart illustrating a method 1400 that supports frequency resource configuration for system information and paging for eRedCap UEs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first control message indicating a downlink BWP spanning a set of multiple sub-bands in a frequency domain. The operations of 1405 may be performed in accordance with examples as disclosed herein. In some examples, aspects of the operations of 1405 may be performed by a control message receiving manager 825 as described with reference to FIG. 8.

At 1410, the method may include receiving a SIB within a first sub-band selected from the set of multiple sub-bands based at least in part on a sub-band index associated with the first sub-band. The operations of 1410 may be performed in accordance with examples as disclosed herein. In some examples, aspects of the operations of 1410 may be performed by an SIB receiving manager 830 as described with reference to FIG. 8.

At 1415, the method may include monitoring, based at least in part on the SIB, a second sub-band for control signaling that schedules the UE to receive additional system information. The operations of 1415 may be performed in accordance with examples as disclosed herein. In some examples, aspects of the operations of 1415 may be performed by a monitoring manager 835 as described with reference to FIG. 8.

At 1420, the method may include receiving a second control message within the second sub-band based at least in part on monitoring the second sub-band, the second control message scheduling the UE to receive the additional system information. The operations of 1420 may be performed in accordance with examples as disclosed herein. In some examples, aspects of the operations of 1420 may be performed by a control message receiving manager 825 as described with reference to FIG. 8.

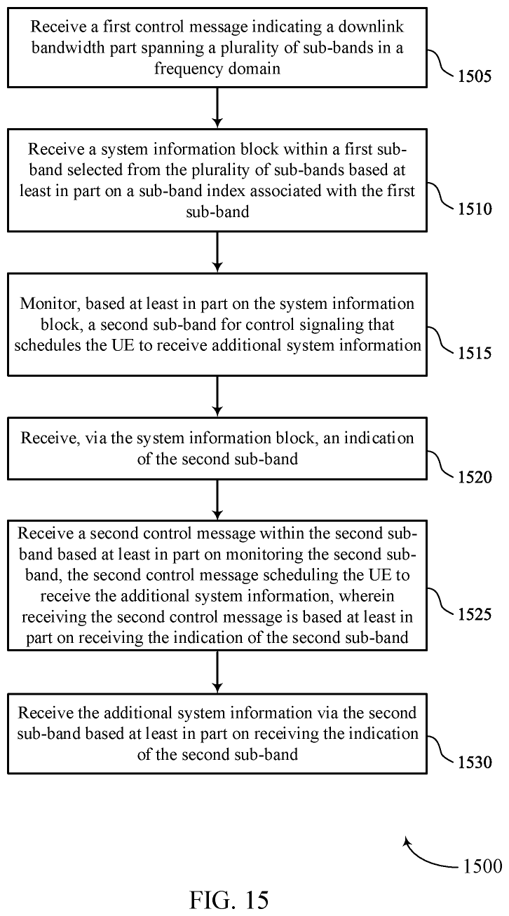

FIG. 15 shows a flowchart illustrating a method 1500 that supports frequency resource configuration for system information and paging for eRedCap UEs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a first control message indicating a downlink BWP spanning a set of multiple sub-bands in a frequency domain. The operations of 1505 may be performed in accordance with examples as disclosed herein. In some examples, aspects of the operations of 1505 may be performed by a control message receiving manager 825 as described with reference to FIG. 8.

At 1510, the method may include receiving a SIB within a first sub-band selected from the set of multiple sub-bands based at least in part on a sub-band index associated with the first sub-band. The operations of 1510 may be performed in accordance with examples as disclosed herein. In some examples, aspects of the operations of 1510 may be performed by an SIB receiving manager 830 as described with reference to FIG. 8.

At 1515, the method may include monitoring, based at least in part on the SIB, a second sub-band for control signaling that schedules the UE to receive additional system information. The operations of 1515 may be performed in accordance with examples as disclosed herein. In some examples, aspects of the operations of 1515 may be performed by a monitoring manager 835 as described with reference to FIG. 8.

At 1520, the method may include receiving, via the SIB, an indication of the second sub-band. The operations of 1520 may be performed in accordance with examples as disclosed herein. In some examples, aspects of the operations of 1520 may be performed by an SIB receiving manager 830 as described with reference to FIG. 8.

At 1525, the method may include receiving a second control message within the second sub-band based at least in part on monitoring the second sub-band, the second control message scheduling the UE to receive the additional system information, where receiving the second control message is based at least in part on receiving the indication of the second sub-band. The operations of 1525 may be performed in accordance with examples as disclosed herein. In some examples, aspects of the operations of 1525 may be performed by a control message receiving manager 825 as described with reference to FIG. 8.

At 1530, the method may include receiving the additional system information via the second sub-band based at least in part on receiving the indication of the second sub-band. The operations of 1530 may be performed in accordance with examples as disclosed herein. In some examples, aspects of the operations of 1530 may be performed by an additional system information receiving manager 840 as described with reference to FIG. 8.

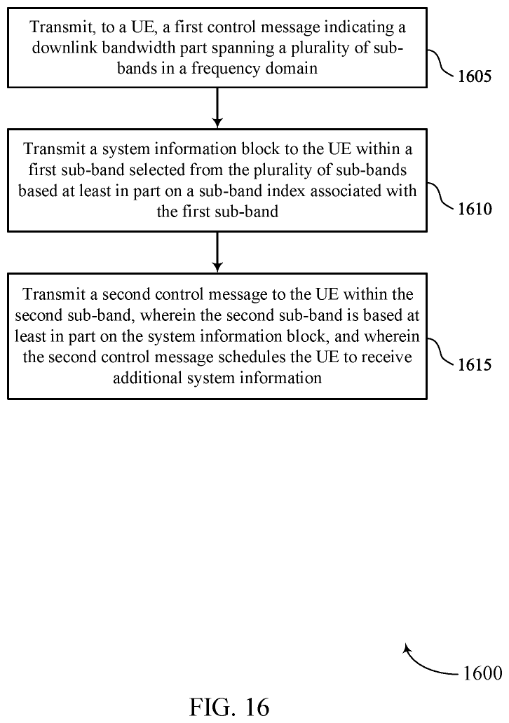

FIG. 16 shows a flowchart illustrating a method 1600 that supports frequency resource configuration for system information and paging for eRedCap UEs in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a first control message indicating a downlink BWP spanning a set of multiple sub-bands in a frequency domain. The operations of 1605 may be performed in accordance with examples as disclosed herein. In some examples, aspects of the operations of 1605 may be performed by a control message transmitting manager 1225 as described with reference to FIG. 12.

At 1610, the method may include transmitting a SIB to the UE within a first sub-band selected from the set of multiple sub-bands based at least in part on a sub-band index associated with the first sub-band. The operations of 1610 may be performed in accordance with examples as disclosed herein. In some examples, aspects of the operations of 1610 may be performed by an SIB transmitting manager 1230 as described with reference to FIG. 12.

At 1615, the method may include transmitting a second control message to the UE within the second sub-band, where the second sub-band is based at least in part on the SIB, and where the second control message schedules the UE to receive additional system information. The operations of 1615 may be performed in accordance with examples as disclosed herein. In some examples, aspects of the operations of 1615 may be performed by a control message transmitting manager 1225 as described with reference to FIG. 12.

The following provides an overview of aspects of the present disclosure:

Aspect 1: A method for wireless communication at a UE, comprising: receiving a first control message indicating a downlink BWP spanning a plurality of sub-bands in a frequency domain; receiving a SIB within a first sub-band selected from the plurality of sub-bands based at least in part on a sub-band index associated with the first sub-band; monitoring, based at least in part on the SIB, a second sub-band for control signaling that schedules the UE to receive additional system information; and receiving a second control message within the second sub-band based at least in part on monitoring the second sub-band, the second control message scheduling the UE to receive the additional system information.

Aspect 2: The method of aspect 1, further comprising: receiving, via the SIB, an indication of the second sub-band, wherein receiving the second control message is based at least in part on receiving the indication of the second sub-band; and receiving the additional system information via the second sub-band based at least in part on receiving the indication of the second sub-band.

Aspect 3: The method of any of aspects 1 through 2, further comprising: receiving, via the SIB, an indication of the second sub-band and an indication of a third sub-band, wherein receiving the second control message is based at least in part on receiving the indication of the second sub-band; and receiving the additional system information via the third sub-band based at least in part on receiving the indication of the third sub-band.

Aspect 4: The method of any of aspects 1 through 3, further comprising: selecting the first sub-band as the second sub-band based at least in part on an absence of an indication of an additional sub-band within the SIB, wherein the second control message is received within the first sub-band based at least in part on the selecting.

Aspect 5: The method of aspect 4, further comprising: receiving the additional system information via the first sub-band based at least in part on selecting the first sub-band as the second sub-band, based at least in part on receiving the second control message via the first sub-band, or both.

Aspect 6: The method of any of aspects 1 through 5, further comprising: receiving a third control message that schedules the SIB within the first sub-band of the plurality of sub-bands; and monitoring the first sub-band for the SIB based at least in part on receiving the third control message via the first sub-band, wherein receiving the SIB is based at least in part on the monitoring.

Aspect 7: The method of any of aspects 1 through 6, further comprising: receiving a third control message that schedules the SIB, the third control message comprising an indication of the first sub-band; and monitoring the first sub-band for the SIB based at least in part on receiving the indication of the first sub-band, wherein receiving the SIB is based at least in part on the monitoring.

Aspect 8: The method of aspect 7, wherein the indication of the first sub-band comprises a CRC portion of the third control message that is scrambled based at least in part on a SI-RNTI.

Aspect 9: The method of aspect 8, wherein the information radio network temporary identifier is associated with eRedCap UEs, and the UE comprises an eRedCap UE.

Aspect 10: The method of any of aspects 1 through 9, further comprising: receiving, via the second control message, an indication of a third sub-band for receiving the additional system information, wherein the third sub-band is the same or different as the first sub-band, the second sub-band, or both; and receiving the additional system information within the third sub-band based at least in part on receiving the indication of the third sub-band.

Aspect 11: The method of any of aspects 1 through 10, further comprising: receiving, via the second control message, an indication of a first subset of sub-bands associated with broadcast system information, and an indication of a second subset of sub-bands associated with on-demand system information, the second subset of sub-bands different from the first subset of sub-bands, wherein the second sub-band is included within the first subset of sub-bands if the additional system information comprises broadcast system information, or wherein the second sub-band is included within the second subset of sub-bands if the additional system information comprises on-demand system information.

Aspect 12: The method of aspect 11, further comprising: transmitting, based at least in part on the second control message, a request for the additional system information based at least in part on the additional system information comprising on-demand system information; and receiving the additional system information within the second sub-band based at least in part on the request.

Aspect 13: The method of any of aspects 1 through 12, further comprising: receiving, via the second control message, an indication of a first subset of sub-bands associated with a first type of additional system information, and an indication of a second subset of sub-bands associated with a second type of additional system information, the second subset of sub-bands different from the first subset of sub-bands, wherein the second sub-band is included within the first subset of sub-bands if the additional system information is of the first type, or wherein the second sub-band is included within the second subset of sub-bands if the additional system information is of the second type.

Aspect 14: The method of any of aspects 1 through 13, further comprising: receiving an indication of a common set of sub-bands associated with broadcast system information, on-demand system information, a first type of additional system information, a second type of additional system information, or any combination thereof.

Aspect 15: The method of any of aspects 1 through 14, further comprising: selecting a third sub-band of the plurality of sub-bands based at least in part on an additional sub-band index associated with the third sub-band, wherein the third sub-band is the same or different as the first sub-band, the second sub-band, or both; and receiving a third control message within the third sub-band, wherein the third control message schedules the UE to receive the SIB.

Aspect 16: The method of aspect 15, wherein each sub-band of the plurality of sub-bands is associated with a respective sub-band index, the method further comprising: selecting the third sub-band based at least in part on the additional sub-band index associated with the third sub-band comprising a highest sub-band index of the plurality of sub-band indices, or based at least in part on the additional sub-band index comprising a lowest sub-band index of the plurality of sub-band indices.

Aspect 17: The method of any of aspects 15 through 16, further comprising: determining the additional sub-band index associated with the third sub-band based at least in part on an SFN, a slot index, or both, wherein the SFN, the slot index, or both, are indicated via the first control message, determined based on a timing of the first control message, or both.

Aspect 18: The method of any of aspects 15 through 17, wherein selecting the sub-band of the plurality of sub-bands is based at least in part on the UE comprising an eRedCap UE.

Aspect 19: The method of any of aspects 1 through 18, further comprising: receiving, via the first control message, the second control message, a paging TRS, paging PEI message, or any combination thereof, an indication of a third sub-band associated with paging resources for the UE, wherein the third sub-band is the same or different as the first sub-band, the second sub-band, or both; and monitoring the third sub-band for a paging message based at least in part on receiving the indication of the third sub-band.

Aspect 20: The method of aspect 19, further comprising: receiving the paging message based at least in part on monitoring the third sub-band, wherein the paging message schedules the UE to receive a downlink message within a fourth sub-band, wherein the fourth sub-band is the same or different as the first sub-band, the second sub-band, the third sub-band, or any combination thereof; and receiving the downlink message within the fourth sub-band based at least in part on the paging message.

Aspect 21: The method of any of aspects 19 through 20, wherein the second sub-band used to receive the second control message that schedules the additional system information is included within a first subset of the plurality of sub-bands, and the third sub-band used to receive the paging message is included within a second subset of the plurality of sub-bands that is different from the first subset.

Aspect 22: The method of any of aspects 1 through 21, wherein the first control message comprises a MIB.

Aspect 23: The method of any of aspects 1 through 22, wherein the second sub-band is included within the plurality of sub-bands spanned by the downlink BWP.

Aspect 24: A method for wireless communication at a network entity, comprising: transmitting, to a UE, a first control message indicating a downlink BWP spanning a plurality of sub-bands in a frequency domain; transmitting a SIB to the UE within a first sub-band selected from the plurality of sub-bands based at least in part on a sub-band index associated with the first sub-band; and transmitting a second control message to the UE within the second sub-band, wherein the second sub-band is based at least in part on the SIB, and wherein the second control message schedules the UE to receive additional system information.

Aspect 25: The method of aspect 24, further comprising: transmitting, via the SIB, an indication of the second sub-band, wherein transmitting the second control message is based at least in part on transmitting the indication of the second sub-band; and transmitting the additional system information via the second sub-band based at least in part on transmitting the indication of the second sub-band.

Aspect 26: The method of any of aspects 24 through 25, further comprising: transmitting, via the SIB, an indication of the second sub-band and an indication of a third sub-band, wherein transmitting the second control message is based at least in part on transmitting the indication of the second sub-band; and transmitting the additional system information via the third sub-band based at least in part on transmitting the indication of the third sub-band.

Aspect 27: The method of any of aspects 24 through 26, further comprising: selecting the first sub-band as the second sub-band based at least in part on an absence of an indication of an additional sub-band within the SIB, wherein the second control message is transmitted within the first sub-band based at least in part on the selecting.

Aspect 28: The method of aspect 27, further comprising: transmitting the additional system information via the first sub-band based at least in part on selecting the first sub-band as the second sub-band, based at least in part on transmitting the second control message via the first sub-band, or both.

Aspect 29: The method of any of aspects 24 through 28, further comprising: transmitting a third control message that schedules the SIB within the first sub-band of the plurality of sub-bands, wherein transmitting the SIB is based at least in part on the third control message.

Aspect 30: The method of any of aspects 24 through 29, further comprising: transmitting a third control message that schedules the SIB, the third control message comprising an indication of the first sub-band, wherein transmitting the SIB is based at least in part on the third control message.

Aspect 31: The method of aspect 30, wherein the indication of the first sub-band comprises a CRC portion of the third control message that is scrambled based at least in part on a SI-RNTI.

Aspect 32: The method of aspect 31, wherein the information radio network temporary identifier is associated with eRedCap UEs, and the UE comprises an eRedCap UE.

Aspect 33: The method of any of aspects 24 through 32, further comprising: transmitting, via the second control message, an indication of a third sub-band for transmitting the additional system information, wherein the third sub-band is the same or different as the first sub-band, the second sub-band, or both; and transmitting the additional system information to the UE within the third sub-band based at least in part on transmitting the indication of the third sub-band.

Aspect 34: The method of any of aspects 24 through 33, further comprising: transmitting, via the second control message, an indication of a first subset of sub-bands associated with broadcast system information, and an indication of a second subset of sub-bands associated with on-demand system information, the second subset of sub-bands different from the first subset of sub-bands, wherein the second sub-band is included within the first subset of sub-bands if the additional system information comprises broadcast system information, or wherein the second sub-band is included within the second subset of sub-bands if the additional system information comprises on-demand system information.

Aspect 35: The method of aspect 34, further comprising: receiving, from the UE based at least in part on the second control message, a request for the additional system information based at least in part on the additional system information comprising on-demand system information; and transmitting the additional system information within the second sub-band based at least in part on the request.

Aspect 36: The method of any of aspects 24 through 35, further comprising: transmitting, via the second control message, an indication of a first subset of sub-bands associated with a first type of additional system information, and an indication of a second subset of sub-bands associated with a second type of additional system information, the second subset of sub-bands different from the first subset of sub-bands, wherein the second sub-band is included within the first subset of sub-bands if the additional system information comprises the first type, or wherein the second sub-band is included within the second subset of sub-bands if the additional system information comprises the second type.

Aspect 37: The method of any of aspects 24 through 36, further comprising: selecting a third sub-band of the plurality of sub-bands based at least in part on an additional sub-band index associated with the third sub-band, wherein the third sub-band is the same or different as the first sub-band, the third sub-band, or both; and transmitting a third control message from the network entity within the third sub-band, wherein the third control message schedules the UE to receive the SIB.

Aspect 38: The method of aspect 37, wherein each sub-band of the plurality of sub-bands is associated with a respective sub-band index, the method further comprising: selecting the third sub-band based at least in part on the additional sub-band index associated with the third sub-band comprising a highest sub-band index of the plurality of sub-band indices, or based at least in part on the additional sub-band index comprising a lowest sub-band index of the plurality of sub-band indices.

Aspect 39: The method of any of aspects 37 through 38, further comprising: determining the additional sub-band index associated with the third sub-band based at least in part on an SFN, a slot index, or both, wherein the SFN, the slot index, or both, are indicated via the first control message, determined based on a timing of the first control message, or both.

Aspect 40: The method of any of aspects 37 through 39, wherein selecting the sub-band of the plurality of sub-bands is based at least in part on the UE comprising an eRedCap UE.

Aspect 41: The method of any of aspects 24 through 40, further comprising: transmitting, via the first control message, the second control message, a paging TRS, paging PEI message, or any combination thereof, an indication of a third sub-band associated with paging resources for the UE, wherein the third sub-band is the same or different as the first sub-band, the second sub-band, or both.

Aspect 42: The method of aspect 41, further comprising: transmitting the paging message based within the third sub-band based at least in part on the indication of the third sub-band, wherein the paging message schedules the UE to receive a downlink message within a fourth sub-band, wherein the fourth sub-band is the same or different as the first sub-band, the second sub-band, the third sub-band, or any combination thereof; and transmitting the downlink message to the UE within the fourth sub-band based at least in part on the paging message.

Aspect 43: The method of any of aspects 41 through 42, wherein the second sub-band used to transmit the second control message that schedules the additional system information is included within a first subset of the plurality of sub-bands, and the third sub-band used to transmit the paging message is included within a second subset of the plurality of sub-bands that is different from the first subset.

Aspect 44: The method of any of aspects 24 through 43, wherein the first control message comprises a MIB.

Aspect 45: The method of any of aspects 24 through 44, wherein the second sub-band is included within the plurality of sub-bands spanned by the downlink BWP.

Aspect 46: An apparatus for wireless communication at a UE, comprising at least one processor, and memory coupled to the at least one processor, the memory storing instructions executable by the at least one processor to cause the UE to perform a method of any of aspects 1 through 23.

Aspect 47: An apparatus for wireless communication at a UE, comprising at least one means for performing a method of any of aspects 1 through 23.

Aspect 48: A non-transitory computer-readable medium storing code for wireless communication at a UE, the code comprising instructions executable by at least one processor to perform a method of any of aspects 1 through 23.

Aspect 49: An apparatus for wireless communication at a network entity, comprising at least one processor, and memory coupled to the at least one processor, the memory storing instructions executable by the at least one processor to cause the network entity to perform a method of any of aspects 24 through 45.

Aspect 50: An apparatus for wireless communication at a network entity, comprising at least one means for performing a method of any of aspects 24 through 45.

Aspect 51: A non-transitory computer-readable medium storing code for wireless communication at a network entity, the code comprising instructions executable by a processor to perform a method of any of aspects 24 through 45.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled with the at least one processor, the memory storing instructions executable by the at least one processor to cause the UE to:
receive a first control message indicating a downlink bandwidth part spanning a plurality of sub-bands in a frequency domain;
receive a system information block within a first sub-band selected from the plurality of sub-bands based at least in part on a sub-band index associated with the first sub-band;
monitor, based at least in part on the system information block, a second sub-band for control signaling that schedules the UE to receive additional system information; and
receive a second control message within the second sub-band based at least in part on monitoring the second sub-band, the second control message scheduling the UE to receive the additional system information.

2. The apparatus of claim 1, wherein the instructions are further executable by the at least one processor to cause the UE to:
receive, via the system information block, an indication of the second sub-band, wherein receiving the second control message is based at least in part on receiving the indication of the second sub-band; and
receive the additional system information via the second sub-band based at least in part on receiving the indication of the second sub-band.

3. The apparatus of claim 1, wherein the instructions are further executable by the at least one processor to cause the UE to:
receive, via the system information block, an indication of the second sub-band and an indication of a third sub-band, wherein receiving the second control message is based at least in part on receiving the indication of the second sub-band; and
receive the additional system information via the third sub-band based at least in part on receiving the indication of the third sub-band.

4. The apparatus of claim 1, wherein the instructions are further executable by the at least one processor to cause the UE to:
select the first sub-band as the second sub-band based at least in part on an absence of an indication of an additional sub-band within the system information block, wherein the second control message is received within the first sub-band based at least in part on the selecting.

5. The apparatus of claim 4, wherein the instructions are further executable by the at least one processor to cause the UE to:
receive the additional system information via the first sub-band based at least in part on selecting the first sub-band as the second sub-band, based at least in part on receiving the second control message via the first sub-band, or both.

6. The apparatus of claim 1, wherein the instructions are further executable by the at least one processor to cause the UE to:
receive a third control message that schedules the system information block within the first sub-band of the plurality of sub-bands; and
monitor the first sub-band for the system information block based at least in part on receiving the third control message via the first sub-band, wherein receiving the system information block is based at least in part on the monitoring.

7. The apparatus of claim 1, wherein the instructions are further executable by the at least one processor to cause the UE to:
receive a third control message that schedules the system information block, the third control message comprising an indication of the first sub-band; and
monitor the first sub-band for the system information block based at least in part on receiving the indication of the first sub-band, wherein receiving the system information block is based at least in part on the monitoring.

8. The apparatus of claim 7, wherein the indication of the first sub-band comprises a cyclic redundancy check portion of the third control message that is scrambled based at least in part on a system information radio network temporary identifier.

9. The apparatus of claim 8, wherein the information radio network temporary identifier is associated with enhanced reduced-capability UEs, and wherein the UE comprises an enhanced reduced-capability UE.

10. The apparatus of claim 1, wherein the instructions are further executable by the at least one processor to cause the UE to:
receive, via the second control message, an indication of a third sub-band for receiving the additional system information, wherein the third sub-band is the same or different as the first sub-band, the second sub-band, or both; and
receive the additional system information within the third sub-band based at least in part on receiving the indication of the third sub-band.

11. The apparatus of claim 1, wherein the instructions are further executable by the at least one processor to cause the UE to:
receive, via the second control message, an indication of a first subset of sub-bands associated with broadcast system information, and an indication of a second subset of sub-bands associated with on-demand system information, the second subset of sub-bands different from the first subset of sub-bands, wherein the second sub-band is included within the first subset of sub-bands if the additional system information comprises broadcast system information, or wherein the second sub-band is included within the second subset of sub-bands if the additional system information comprises on-demand system information.

12. The apparatus of claim 11, wherein the instructions are further executable by the at least one processor to cause the UE to:
transmit, based at least in part on the second control message, a request for the additional system information based at least in part on the additional system information comprising on-demand system information; and
receive the additional system information within the second sub-band based at least in part on the request.

13. The apparatus of claim 1, wherein the instructions are further executable by the at least one processor to cause the UE to:
receive, via the second control message, an indication of a first subset of sub-bands associated with a first type of additional system information, and an indication of a second subset of sub-bands associated with a second type of additional system information, the second subset of sub-bands different from the first subset of sub-bands, wherein the second sub-band is included within the first subset of sub-bands if the additional system information is of the first type, or wherein the second sub-band is included within the second subset of sub-bands if the additional system information is of the second type.

14. The apparatus of claim 1, wherein the instructions are further executable by the at least one processor to cause the UE to:
receive an indication of a common set of sub-bands associated with broadcast system information, on-demand system information, a first type of additional system information, a second type of additional system information, or any combination thereof.

15. The apparatus of claim 1, wherein the instructions are further executable by the at least one processor to cause the UE to:
select a third sub-band of the plurality of sub-bands based at least in part on an additional sub-band index associated with the third sub-band, wherein the third sub-band is the same or different as the first sub-band, the second sub-band, or both; and
receive a third control message within the third sub-band, wherein the third control message schedules the UE to receive the system information block.

16. The apparatus of claim 15, wherein each sub-band of the plurality of sub-bands is associated with a respective sub-band index, and the instructions are further executable by the at least one processor to cause the UE to:
select the third sub-band based at least in part on the additional sub-band index associated with the third sub-band comprising a highest sub-band index of the plurality of sub-band indices, or based at least in part on the additional sub-band index comprising a lowest sub-band index of the plurality of sub-band indices.

17. The apparatus of claim 15, wherein the instructions are further executable by the at least one processor to cause the UE to:
determine the additional sub-band index associated with the third sub-band based at least in part on a system frame number, a slot index, or both, wherein the system frame number, the slot index, or both, are indicated via the first control message, determined based on a timing of the first control message, or both.

18. The apparatus of claim 15, wherein selecting the sub-band of the plurality of sub-bands is based at least in part on the UE comprising an enhanced reduced-capability UE.

19. The apparatus of claim 1, wherein the instructions are further executable by the at least one processor to cause the UE to:
receive, via the first control message, the second control message, a paging tracking reference signal, paging permanent equipment identifier message, or any combination thereof, an indication of a third sub-band associated with paging resources for the UE, wherein the third sub-band is the same or different as the first sub-band, the second sub-band, or both; and
monitor the third sub-band for a paging message based at least in part on receiving the indication of the third sub-band.

20. The apparatus of claim 19, wherein the instructions are further executable by the at least one processor to cause the UE to:
receive the paging message based at least in part on monitoring the third sub-band, wherein the paging message schedules the UE to receive a downlink message within a fourth sub-band, wherein the fourth sub-band is the same or different as the first sub-band, the second sub-band, the third sub-band, or any combination thereof; and
receive the downlink message within the fourth sub-band based at least in part on the paging message.

21. The apparatus of claim 19, wherein the second sub-band used to receive the second control message that schedules the additional system information is included within a first subset of the plurality of sub-bands, and wherein the third sub-band used to receive the paging message is included within a second subset of the plurality of sub-bands that is different from the first subset.

22. The apparatus of claim 1, wherein the first control message comprises a master information block.

23. The apparatus of claim 1, wherein the second sub-band is included within the plurality of sub-bands spanned by the downlink bandwidth part.

24. An apparatus for wireless communication at a network entity, comprising:
at least one processor; and
memory coupled with the at least one processor, the memory storing instructions executable by the at least one processor to cause the network entity to:
transmit, to a user equipment (UE), a first control message indicating a downlink bandwidth part spanning a plurality of sub-bands in a frequency domain;
transmit a system information block to the UE within a first sub-band selected from the plurality of sub-bands based at least in part on a sub-band index associated with the first sub-band; and
transmit a second control message to the UE within the second sub-band, wherein the second sub-band is based at least in part on the system information block, and wherein the second control message schedules the UE to receive additional system information.

25. The apparatus of claim 24, wherein the instructions are further executable by the at least one processor to cause the network entity to:
transmit, via the system information block, an indication of the second sub-band, wherein transmitting the second control message is based at least in part on transmitting the indication of the second sub-band; and
transmit the additional system information via the second sub-band based at least in part on transmitting the indication of the second sub-band.

26. The apparatus of claim 24, wherein the instructions are further executable by the at least one processor to cause the network entity to:
transmit, via the system information block, an indication of the second sub-band and an indication of a third sub-band, wherein transmitting the second control message is based at least in part on transmitting the indication of the second sub-band; and
transmit the additional system information via the third sub-band based at least in part on transmitting the indication of the third sub-band.

27. The apparatus of claim 24, wherein the instructions are further executable by the at least one processor to cause the network entity to:
select the first sub-band as the second sub-band based at least in part on an absence of an indication of an additional sub-band within the system information block, wherein the second control message is transmitted within the first sub-band based at least in part on the selecting.

28. The apparatus of claim 27, wherein the instructions are further executable by the at least one processor to cause the network entity to:
transmit the additional system information via the first sub-band based at least in part on selecting the first sub-band as the second sub-band, based at least in part on transmitting the second control message via the first sub-band, or both.

29. A method for wireless communication at a user equipment (UE), comprising:
receiving a first control message indicating a downlink bandwidth part spanning a plurality of sub-bands in a frequency domain;
receiving a system information block within a first sub-band selected from the plurality of sub-bands based at least in part on a sub-band index associated with the first sub-band;
monitoring, based at least in part on the system information block, a second sub-band for control signaling that schedules the UE to receive additional system information; and
receiving a second control message within the second sub-band based at least in part on monitoring the second sub-band, the second control message scheduling the UE to receive the additional system information.

30. A method for wireless communication at a network entity, comprising:
transmitting, to a user equipment (UE), a first control message indicating a downlink bandwidth part spanning a plurality of sub-bands in a frequency domain;
transmitting a system information block to the UE within a first sub-band selected from the plurality of sub-bands based at least in part on a sub-band index associated with the first sub-band; and
transmitting a second control message to the UE within the second sub-band, wherein the second sub-band is based at least in part on the system information block, and wherein the second control message schedules the UE to receive additional system information.
